(19) United States
(12) Patent Application Publication
(10) Pub. No.: US 2014/0284000 A1
(43) Pub. Date: Sep. 25, 2014

(54) SEPARATION APPARATUS, SEPARATION SYSTEM, SEPARATION METHOD AND NON-TRANSITORY COMPUTER READABLE STORAGE MEDIUM

(71) Applicant: TOKYO ELECTRON LIMITED, Tokyo (JP)

(72) Inventors: Yasutaka SOMA, Koshi City (JP); Naoto YOSHITAKA, Koshi City (JP); Hiroshi KOMEDA, Koshi City (JP); Eiji MANABE, Koshi City (JP); Osamu HIRAKAWA, Koshi City (JP); Masatoshi DEGUCHI, Kikuchi-gun (JP); Takeshi TAMURA, Koshi City (JP)

(21) Appl. No.: 14/300,356

(22) Filed: Jun. 10, 2014

Related U.S. Application Data
(63) Continuation of application No. 13/524,413, filed on Jun. 15, 2012.

(30) Foreign Application Priority Data
Jul. 1, 2011 (JP) 2011-147263
Apr. 26, 2012 (JP) 2012-100857

(51) Int. Cl. B32B 43/00

(52) U.S. Cl. CPC B32B 43/006
USPC 156/711; 156/767; 156/752; 156/714

(57) ABSTRACT

A separation apparatus for separating a superposed substrate into a processing target substrate and a supporting substrate, includes: one holding part holding the processing target substrate via a tape; another holding part holding the supporting substrate; and a moving mechanism moving the another holding part in a vertical direction while holding an outer peripheral portion thereof to continuously separate the supporting substrate held by the another holding part from the processing target substrate held by the one holding part starting from an outer peripheral portion toward a central portion of the supporting substrate, wherein the moving mechanism includes: a first moving part holding the another holding part and moving only the outer peripheral portion of the another holding part in the vertical direction; and a second moving part moving the first moving part and the another holding part in the vertical direction.

### BACKGROUND OF THE INVENTION

1. Field of the Invention

The present invention relates to a separation apparatus for separating a superposed substrate into a processing target substrate and a supporting substrate while the superposed substrate is placed inside an annular frame and held by a tape bonded to a surface of the frame and a non-joint surface of the processing target substrate, a separation system including the separation apparatus, a separation method using the separation apparatus, and a non-transitory computer readable storage medium.

This application is based upon and claims the benefit of priority of the prior Japanese Patent Application No. 2011-147263, filed in Japan on Jul. 1, 2011, and the prior Japanese Patent Application No. 2012-100857, filed in Japan on Apr. 26, 2012, the entire contents of which are incorporated herein by reference.

2. Description of the Related Art

In recent years, for example, in a manufacturing process of a semiconductor device, the diameter of a semiconductor wafer (hereinafter, referred to as a “wafer”) increasingly becomes larger. Further, the wafer is required to be thinner in a specific process such as mounting. For example, when a thin wafer with a large diameter is transferred or subjected to polishing as it is, warpage or break can occur in the wafer. Therefore, in order to reinforce the wafer, for example, bonding the wafer to a wafer being a supporting substrate or a glass substrate is performed. The predetermined processing such as polishing and the like is performed on the wafer with the wafer being joined with the supporting substrate as described above, and then the wafer and the supporting substrate are separated from each other.

The separation of the wafer and the supporting substrate is performed using, for example, a separation apparatus. The separation apparatus has, for example, a first holder holding the wafer, a second holder holding the supporting substrate, and a nozzle jetting liquid between the wafer and the supporting substrate. Then, in this separation apparatus, by jetting liquid between the joined wafer and supporting substrate from the nozzle at a jetting pressure greater than the joint strength between the wafer and the supporting substrate, preferably, a jetting pressure twice or more than the joint strength, the separation of the wafer and the supporting substrate is performed (Japanese Laid-open Patent Publication H9-167724). Thereafter, each of the joint surface of the wafer and the joint surface of the supporting substrate is cleaned, with which the separation processing of the wafer and the supporting substrate ends.

### SUMMARY OF THE INVENTION

However, in the case of using the separation apparatus disclosed in Japanese Patent Application Publication No. H9-167724, liquid is jetted at a jetting pressure larger than a joint strength, so that the wafer or the supporting substrate may be damaged. In particular, the wafer has been thinned and is thus more likely to be damaged.

Further, in the case where the wafer and the supporting substrate are joined together, for example, via an adhesive, the joint strength between the wafer and the supporting substrate is large, so that the liquid at an extremely large jetting pressure is required and a lot of time is necessary to separate the wafer from the supporting substrate.

The present invention has been made in consideration of the above points and its object is to appropriately and efficiently perform separation processing of a processing target substrate and a supporting substrate.

To achieve the above object, the present invention is a separation apparatus for separating a superposed substrate in which a processing target substrate and a supporting substrate are joined together with an adhesive, into the processing target substrate and the supporting substrate while the superposed substrate is placed inside an annular frame and held by a tape bonded to a surface of the frame and a non-joint surface of the processing target substrate, the separation apparatus including: one holding part holding the processing target substrate via the tape; another holding part holding the supporting substrate; and a moving mechanism moving the another holding part in a vertical direction while holding an outer peripheral portion thereof to continuously separate the supporting substrate held by the another holding part from the processing target substrate held by the one holding part starting from an outer peripheral portion toward a central portion of the supporting substrate, wherein the moving mechanism includes: a first moving part holding the another holding part and moving only the outer peripheral portion of the another holding part in the vertical direction; and a second moving part moving the first moving part and the another holding part in the vertical direction. Note that the non-joint surface of the processing target substrate means a surface of the processing target substrate not joined with the supporting substrate in the superposed substrate.

According to the present invention, it is possible to move the outer peripheral portion of the another holding part in the vertical direction, while the processing target substrate is held by the one holding part and the supporting substrate is held by the another holding part, to continuously separate the supporting substrate from the processing target substrate starting from an outer peripheral portion toward a central portion of the supporting substrate. In this case, no physical load is directly applied to the processing target substrate and the supporting substrate in separating the superposed substrate. In addition, it is possible to continuously separate the supporting substrate from the processing target substrate and thereby easily separate the supporting substrate from the processing target substrate with a smaller load than that in a prior art. Therefore, it is possible to appropriately and uniformly separate the supporting substrate from the processing target substrate without damaging the processing target substrate. Further, the time period required for the separation processing can be made shorter than that in the prior art. As described above, according to the present invention, it is possible to appropriately and efficiently perform separation processing of the processing target substrate and the supporting substrate.

The present invention according to another aspect is a separation apparatus for separating a superposed substrate in which a processing target substrate and a supporting substrate are joined together with an adhesive, into the processing target substrate and the supporting substrate while the superposed substrate is placed inside an annular frame and held by a tape bonded to a surface of the frame and a non-joint surface of the processing target substrate, the separation apparatus including: one holding part holding the processing target substrate via the tape; another holding part holding the supporting substrate; a moving mechanism moving the another holding part in a vertical direction while holding an outer peripheral portion thereof to continuously separate the supporting substrate held by the another holding part from the processing target substrate held by the one holding part starting from an outer peripheral portion toward a central portion of the supporting substrate; and a control unit controlling the one holding part, the another holding part, and the moving mechanism to perform a first step of moving the outer peripheral portion of the another holding part in the vertical direction, while holding the processing target substrate by the one holding part and holding the supporting substrate by the another holding part, to continuously separate the supporting substrate from the processing target substrate starting from the outer peripheral portion toward the central portion, and a second step of then moving the whole another holding part in the vertical direction to separate the supporting substrate from the processing target substrate.

The present invention according to still another aspect is a separation system including a separation apparatus for separating a superposed substrate in which a processing target substrate and a supporting substrate are joined together with an adhesive, into the processing target substrate and the supporting substrate while the superposed substrate is placed inside an annular frame and held by a tape bonded to a surface of the frame and a non-joint surface of the processing target substrate, the separation apparatus including: one holding part holding the processing target substrate via the tape; another holding part holding the supporting substrate; and a moving mechanism moving the another holding part in a vertical direction while holding an outer peripheral portion thereof to continuously separate the supporting substrate held by the another holding part from the processing target substrate held by the one holding part starting from an outer peripheral portion toward a central portion of the supporting substrate, the moving mechanism including: a first moving part holding the another holding part and moving only the outer peripheral portion of the another holding part in the vertical direction; and a second moving part moving the first moving part and the another holding part in the vertical direction, the separation system including: a separation processing station including the separation apparatus, a first cleaning apparatus cleaning the processing target substrate separated in the separation apparatus, and a second cleaning apparatus cleaning the supporting substrate separated in the separation apparatus; a transfer-in/out station transferring the processing target substrate, the supporting substrate, or the superposed substrate into/from the separation processing station; and a transfer apparatus transferring the processing target substrate, the supporting substrate, or the superposed substrate between the separation processing station and the transfer-in/out station.

The present invention according to yet another aspect is a separation method of separating, using a separation apparatus, a superposed substrate in which a processing target substrate and a supporting substrate are joined together with an adhesive, into the processing target substrate and the supporting substrate while the superposed substrate is placed inside an annular frame and held by a tape bonded to a surface of the frame and a non-joint surface of the processing target substrate, the separation apparatus including: one holding part holding the processing target substrate via the tape; another holding part holding the supporting substrate; and a moving mechanism moving the another holding part in a vertical direction while holding an outer peripheral portion thereof to continuously separate the supporting substrate held by the another holding part from the processing target substrate held by the one holding part starting from an outer peripheral portion toward a central portion of the supporting substrate, the separation method including: a first step of moving the outer peripheral portion of the another holding part in the vertical direction, while holding the processing target substrate by the one holding part and holding the supporting substrate by the another holding part, to continuously separate the supporting substrate from the processing target substrate starting from the outer peripheral portion toward the central portion; and a second step of then moving the whole another holding part in the vertical direction to separate the supporting substrate from the processing target substrate.

The present invention according to further another aspect is a non-transitory computer readable storage medium storing a program running on a computer of a control unit controlling a separation apparatus to cause the separation apparatus to perform a separation method of separating, using a separation apparatus, a superposed substrate in which a processing target substrate and a supporting substrate are joined together with an adhesive, into the processing target substrate and the supporting substrate while the superposed substrate is placed inside an annular frame and held by a tape bonded to a surface of the frame and a non-joint surface of the processing target substrate, the separation apparatus including: one holding part holding the processing target substrate via the tape; another holding part holding the supporting substrate; and a moving mechanism moving the another holding part in a vertical direction while holding an outer peripheral portion thereof to continuously separate the supporting substrate held by the another holding part from the processing target substrate held by the one holding part starting from an outer peripheral portion toward a central portion of the supporting substrate, and the separation method including: a first step of moving the outer peripheral portion of the another holding part in the vertical direction, while holding the processing target substrate by the one holding part and holding the supporting substrate by the another holding part, to continuously separate the supporting substrate from the processing target substrate starting from the outer peripheral portion toward the central portion; and a second step of then moving the whole another holding part in the vertical direction to separate the supporting substrate from the processing target substrate.

According to the present invention, it is possible to appropriately and efficiently perform separation processing of a processing target substrate and a supporting substrate.

### BRIEF DESCRIPTION OF THE DRAWINGS

FIG. 1 is a plan view illustrating the outline of the configuration of a separation system according to this embodiment;

FIG. 2 is a longitudinal sectional view of a superposed wafer held by a dicing frame and a dicing tape;

FIG. 3 is a plan view of the superposed wafer held by the dicing frame and the dicing tape;

FIG. 4 is a longitudinal sectional view illustrating the outline of the configuration of a separation apparatus;

FIG. 5 is a longitudinal sectional view illustrating the outline of the configurations of a first holding part, a second holding part, and a third holding part;

FIG. 6 is a plan view illustrating the outline of the configuration of the second holding part;

FIG. 7 is a plan view illustrating the outline of the configuration of a first vertical moving part;

FIG. 8 is a longitudinal sectional view illustrating the outline of the configuration of a cleaning apparatus;

FIG. 9 is a longitudinal sectional view illustrating the outline of the configuration of a cleaning jig;

FIG. 10 is a transverse sectional view illustrating the outline of the configuration of the cleaning apparatus;

FIG. 11 is a side view illustrating the outline of the configuration of a delivery arm;

FIG. 12 is a side view illustrating the outline of the configuration of a transfer apparatus;

FIG. 13 is a plan view illustrating the outline of the configuration of a first transfer arm;

FIG. 14 is a plan view illustrating the outline of the configuration of a second transfer arm;

FIG. 15 is an explanatory view illustrating the appearance in which the superposed wafer is held by the first holding part, the second holding part, and the third holding part;

FIG. 16 is an explanatory view illustrating the appearance in which the first vertical moving part moves the outer peripheral portion of the third holding part vertically downward;

FIG. 17 is an explanatory view illustrating the appearance in which a second vertical moving part moves the third holding part vertically downward;

FIG. 18 is an explanatory view illustrating the appearance in which the processing target wafer and the supporting wafer are separated from each other;

FIG. 19A is an explanatory view illustrating the appearance in which the cleaning jig is placed at a predetermined position when cleaning the processing target wafer in the cleaning apparatus;

FIG. 19B is an explanatory view illustrating the appearance in which a solvent is supplied from a solvent supply part to a gap between the supply surface and the joint surface when cleaning the processing target wafer in the cleaning apparatus;

FIG. 19C is an explanatory view illustrating the appearance in which the solvent has diffused in the gap when cleaning the processing target wafer in the cleaning apparatus;

FIG. 19D is an explanatory view illustrating the appearance in which a rinse solution is supplied from a rinse solution supply part to the gap when cleaning the processing target wafer in the cleaning apparatus;

FIG. 19E is an explanatory view illustrating the appearance in which a mixed solution has diffused in the gap when cleaning the processing target wafer in the cleaning apparatus;

FIG. 19F is an explanatory view illustrating the appearance in which an inert gas is supplied from an inert gas supply part to the gap when cleaning the processing target wafer in the cleaning apparatus;

FIG. 20 is a longitudinal sectional view illustrating the outline of the configuration of a cleaning jig according to another embodiment;

FIG. 21 is a plan view illustrating the outline of the configuration of the cleaning jig according to another embodiment;

FIG. 22 is an explanatory view illustrating the appearance in which the solvent is diffused using the cleaning jig according to another embodiment;

FIG. 23 is a longitudinal sectional view illustrating the outline of the configuration of a cleaning apparatus according to another embodiment;

FIG. 24 is a longitudinal sectional view illustrating the outline of the configuration of a cleaning apparatus according to another embodiment;

FIG. 25 is a longitudinal sectional view illustrating the outline of the configuration of a cleaning jig according to another embodiment;

FIG. 26 is a plan view illustrating the outline of the configuration of a cleaning jig (mesh plate) according to another embodiment;

FIG. 27 is an explanatory view illustrating the appearance in which the solvent is diffused using the cleaning jig (mesh plate) according to another embodiment;

FIG. 28 is a longitudinal sectional view illustrating the outline of the configuration of a cleaning apparatus according to another embodiment;

FIG. 29 is a longitudinal sectional view illustrating the outline of the configuration of a cleaning apparatus according to another embodiment;

FIG. 30 is a longitudinal sectional view illustrating the outline of the configuration of a cleaning apparatus according to another embodiment;

FIG. 31 is an explanatory view illustrating the appearance in which the solvent is diffused using a cleaning jig according to another embodiment;

FIG. 32 is a longitudinal sectional view illustrating the outline of the configuration of a cleaning jig according to another embodiment;

FIG. 33 is a longitudinal sectional view illustrating the outline of the configuration of a cleaning apparatus according to another embodiment;

FIG. 34 is a plan view illustrating the outline of the configuration of a separation system according to another embodiment;

FIG. 35 is a side view illustrating the outline of the configuration of a second transfer apparatus;

FIG. 36 is a plan view illustrating the outline of the configuration of a transfer arm;

FIG. 37 is a longitudinal sectional view illustrating the outline of the configuration of a second cleaning apparatus;

FIG. 38 is a transverse sectional view illustrating the outline of the configuration of the second cleaning apparatus;

FIG. 39 is an explanatory view illustrating the appearance in which the processing target wafer is delivered from a first holding part and a second holding part to the transfer arm;

FIG. 40 is an explanatory view illustrating the appearance in which the processing target wafer is delivered from the transfer arm to a wafer holding part;

FIG. 41 is a longitudinal sectional view illustrating the appearance in which a protective tape is provided on a dicing frame at a stepped portion between the processing target wafer and the dicing frame in another embodiment; and

FIG. 42 is a longitudinal sectional view illustrating the appearance in which the protective tape is provided on the dicing frame at the stepped portion between the processing target wafer and the dicing frame in another embodiment.

### DETAILED DESCRIPTION OF THE INVENTION

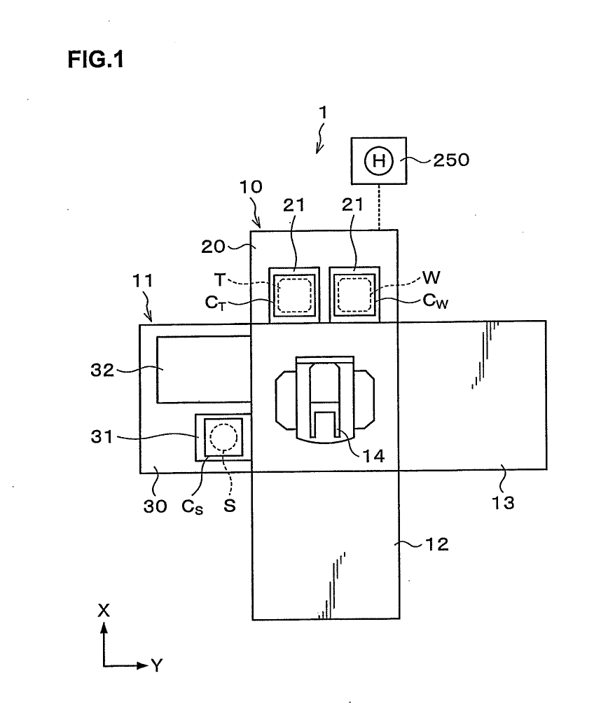

Hereinafter, embodiments of the present invention will be described. FIG. 1 is a plan view illustrating the outline of the configuration of a separation system 1 according to this embodiment.

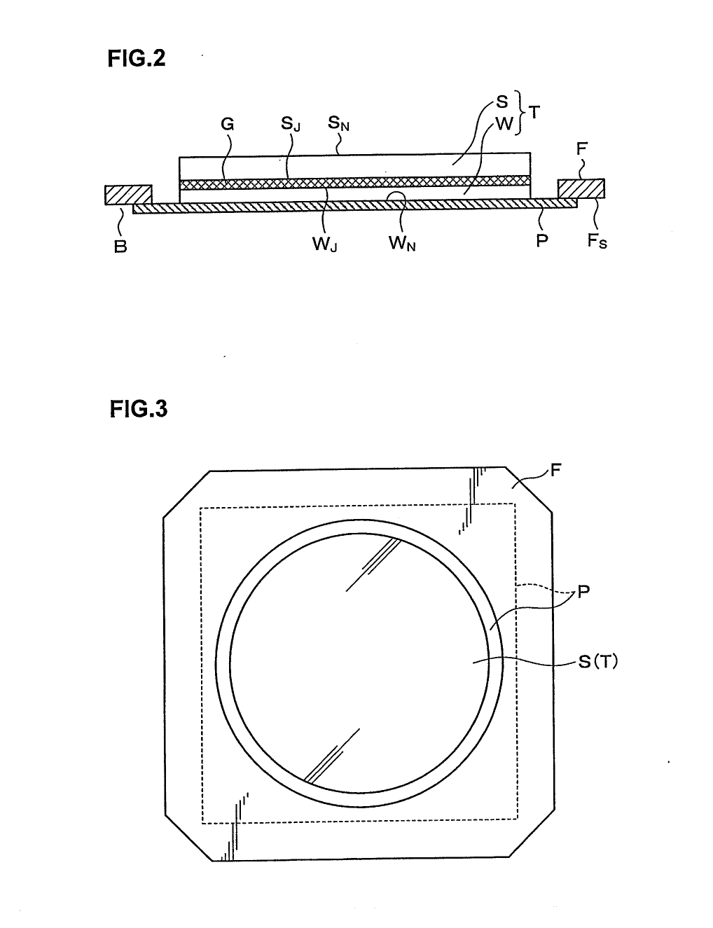

In the separation system 1, a superposed wafer T as a superposed substrate in which a processing target wafer W as a processing target substrate and a supporting wafer S as a supporting substrate are joined together with an adhesive G as illustrated in FIG. 2 and FIG. 3 is separated into the processing target wafer W and the supporting wafer S. Hereinafter, in the processing target wafer W, the surface to be joined with the supporting wafer S via the adhesive G is referred to as a “joint surface W_{J}” and the surface opposite to the joint surface W_{J} is referred to as “a non-joint surface W_{N}.” Similarly, in the supporting wafer S, the surface to be joined with the processing target wafer W via the adhesive G is referred to as a “joint surface S_{J}” and the surface opposite to the joint surface S_{J} is referred to as “a non-joint surface S_{N}.” Note that the processing target wafer W is a wafer which will be a product and has a plurality of electronic circuits formed, for example, on the joint surface W_{J}. Further, in the processing target wafer W, for example, the non-joint surface W_{N} has been subjected to polishing to be thinned (for example, with a thickness of 50 μm). The supporting wafer S is a wafer which has the same diameter as that of the processing target wafer W and supports the processing target wafer W. Note that a case of using a wafer as the supporting substrate will be described in this embodiment, but other substrates such as, for example, a glass substrate and the like may be used.

On the superposed wafer T, a dicing frame F and a dicing tape P are attached. The dicing frame F has an almost rectangular shape in a plan view, and has at its inside an annular shape having an opening formed along the outer peripheral portion of the superposed wafer T. Then, the superposed wafer T is placed in the opening inside the dicing frame F. Note that for the dicing frame F, for example, stainless steel is used. Further, the dicing tape P is bonded on a surface F_{S} of the dicing frame F and the non-joint surface W_{N} of the processing target wafer W. In this manner, the superposed wafer T is held by the dicing frame F and the dicing tape P. Note that the dicing tape P is not bonded to the end portion of the surface F_{S} of the dicing frame F, but a step B corresponding to the thickness of the dicing tape P exists outside the dicing tape P at the outer peripheral portion of the dicing frame F for convenience of manufacture.

In the separation system 1, the superposed wafer T is separated into the processing target wafer W and the supporting wafer S with the superposed wafer T being held by the dicing frame F and the dicing tape P. Further, the separated processing target wafer W is transferred and subjected to subsequent treatment, for example, cleaning of the joint surface W_{J} with the separated processing target wafer W being held by the dicing frame F and the dicing tape P.

The separation system 1 has, as illustrates in FIG. 1, a first transfer-in/out station 10 into/from which cassettes C_{W}, C_{T} capable of housing a plurality of processing target wafers W and a plurality of superposed wafers T respectively are transferred from/to the outside, a second transfer-in/out station 11 into/from which a cassette C_{S} capable of housing a plurality of processing target wafers S is transferred from/to the outside, a separation apparatus 12 separating the superposed wafer T into the processing target wafer W and the supporting wafer S, a cleaning apparatus 13 cleaning the separated processing target wafer W, and a transfer apparatus 14 transferring the processing target wafer W, the supporting wafer S, and the superposed wafer T in the separation system 1. The first transfer-in/out station 10, the second transfer-in/out station 11, the separation apparatus 12, and the cleaning apparatus 13 are arranged around the transfer apparatus 14 in this order, for example, in a counterclockwise direction in a plan view.

In the first transfer-in/out station 10, a cassette mounting table 20 is provided. On the cassette mounting table 20, for example, two cassette mounting plates 21 are provided. The cassette mounting plates 21 are arranged side by side in a Y-direction (a right-left direction in FIG. 1). On these cassette mounting plates 21, the cassettes C_{W}, C_{T} can be mounted when the cassettes C_{W}, C_{T} are transferred in/out from/to the outside of the separation system 1. As described above, the first transfer-in/out station 10 is configured to be able to hold the plurality of processing target wafers W and the plurality of superposed wafers T. Note that each of the processing target wafer W and the superposed wafer T is held by the dicing frame F and the dicing tape P. Further, the number of cassette mounting plates 21 in the first transfer-in/out station 10 is not limited to this embodiment but can be arbitrarily determined.

In the second transfer-in/out station 11, a cassette mounting table 30 is provided. On the cassette mounting table 30, for example, one cassette mounting plate 31 is provided. On the cassette mounting plate 31, the cassette C_{S} can be mounted when the cassette C_{S} is transferred in/out from/to the outside of the separation system 1. As described above, the second transfer-in/out station 11 is configured to be able to hold the plurality of supporting wafers S. Further, a reversing apparatus 32 reversing the front and rear surfaces of the processing target wafer W is placed adjacent to the cassette mounting plate 31 and on an X-direction positive direction (an upper direction in FIG. 1) side.

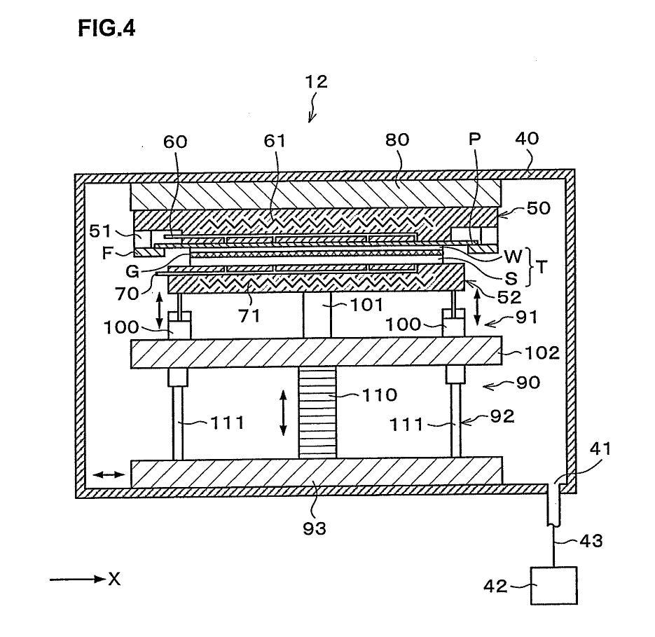

Next, the configuration of the above-described separation apparatus 12 will be described. The separation apparatus 12 has a processing container 40 as illustrated in FIG. 4. In a side surface of the processing container 40, a transfer-in/out port (not illustrated) for the processing target wafer W, the supporting wafer S, and the superposed wafer T is formed, and an opening/closing shutter (not illustrated) is provided at the transfer-in/out port. Note that an atmosphere from a region where the transfer apparatus 14 is provided flows into the processing container 40. Further, each of the processing target wafer W and the superposed wafer T is held by the dicing frame F and the dicing tape P.

At the bottom surface of the processing container 40, a suction port 41 sucking the atmosphere inside the processing container 40 is formed. A suction pipe 43 communicating with a negative pressure generating device 42 such as, for example, a vacuum pump is connected to the suction port 41.

Inside the processing container 40, a first holding part 50 suction-holding the processing target wafer W by its lower surface, a second holding part 51 suction-holding the surface F_{S} of the dicing frame F, and a third holding part 52 mounting and holding the supporting wafer S on its upper surface are provided. Each of the first holding part 50 and the second holding part 51 is provided above the third holding part 52, and the first holding part 50 is arranged to face the third holding part 52. In other words, inside the processing container 40, the separation processing is performed on the superposed wafer T with the processing target wafer W placed on the upper side and the supporting wafer S placed on the lower side.

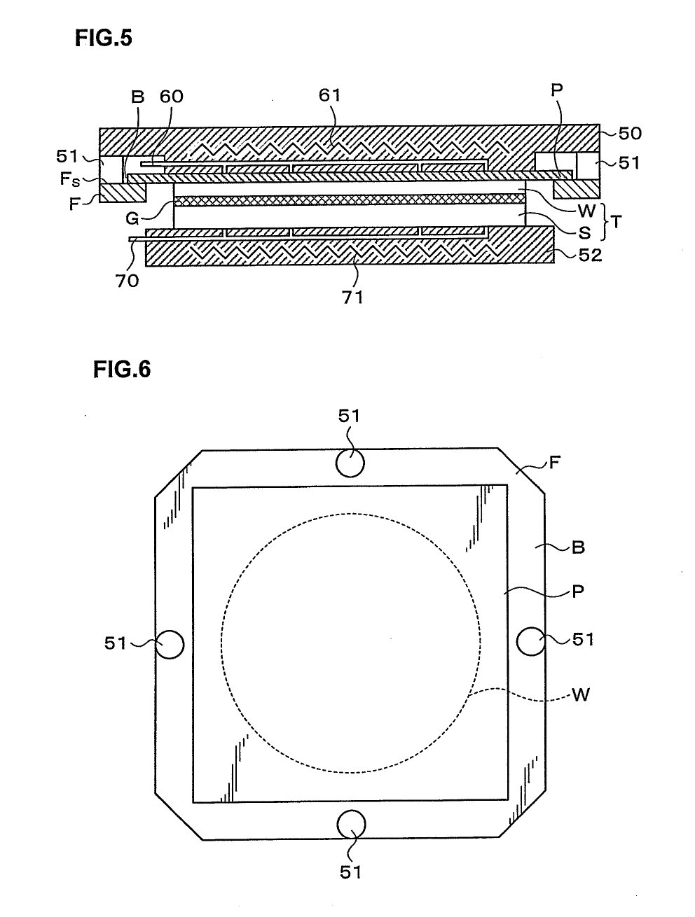

The first holding part 50 has an almost flat plate shape as illustrated in FIG. 5. Inside the first holding part 50, a suction pipe 60 is provided for suction-holding the non-joint surface W_{N} of the processing target wafer W via the dicing tape P. The suction pipe 60 is connected to a negative pressure generating device (not illustrated) such as, for example, a vacuum pump.

Further, inside the first holding part 50, a heating mechanism 61 heating the processing target wafer W is provided. For the heating mechanism 61, for example, a heater is used.

The second holding part 51 is provided integrally with the first holding part 50 at the outer peripheral portion of the first holding part 50. In other words, the second holding part 51 is arranged outside the dicing tape P. Further, to the second holding part 51, a negative pressure generating device (not illustrated) such as, for example, a vacuum pump is connected, so that the second holding part 51 can suction-hold the surface F_{S} of the dicing frame F outside the dicing tape P. Note that the second holding part 51 is provided at a plurality of positions, for example, four positions as illustrated in FIG. 6. The four second holding parts 51 are arranged at regular intervals at respective sides of the dicing frame F.

Here, the step B exists outside the dicing tape P at the outer peripheral portion of the dicing frame F as described above. For this reason, when the first holding part 50 tries to suction-hold the dicing frame F, a gap due to the step B is generated between the first holding part 50 and the dicing frame F. In other words, the first holding part 50 cannot directly suction-hold the dicing frame F. In this case, since the dicing frame F is not fixed, the processing target wafer W is not appropriately held by the first holding part 50. In this regard, the dicing frame F is suction-held by the second holding part 51 in this embodiment, so that the processing target wafer W is also appropriately held by the first holding part 50.

The third holding part 52 has an almost flat plate shape as illustrated in FIG. 5. Inside the third holding part 52, a suction pipe 70 is provided for suction-holding the supporting wafer S. The suction pipe 70 is connected to a negative pressure generating device (not illustrated) such as, for example, a vacuum pump. Note that for the third holding part 52, for example, aluminum being an elastic body is used.

Further, inside the third holding part 52, a heating mechanism 71 heating the supporting wafer S is provided. For the heating mechanism 71, for example, a heater made of aluminum is used.

On the upper surface of the first holding part 50, a supporting plate 80 supporting the first holding part 50 is provided as illustrated in FIG. 4. The supporting plate 80 is supported on the ceiling surface of the processing container 40. Note that the supporting plate 80 of this embodiment may be omitted, and the first holding part 50 may be in abutment with and supported by the ceiling surface of the processing container 40.

Below the third holding part 52, a moving mechanism 90 is provided which moves the third holding part 52 and the supporting wafer S in the vertical direction and the horizontal direction. The moving mechanism 90 has a first vertical moving part 91 holding the third holding part 52 and moving only the outer peripheral portion of the third holding part 52 in the vertical direction, a second vertical moving part 92 holding the first vertical moving part 91 and moving the first vertical moving part 91 and the third holding part 52 in the vertical direction, and a horizontal moving part 93 moving the first vertical moving part 91, the second vertical moving part 92, and the third holding part 52 in the horizontal direction. The first vertical moving part 91, the second vertical moving part 92, and the horizontal moving part 93 are arranged in this order from the top in the vertical direction.

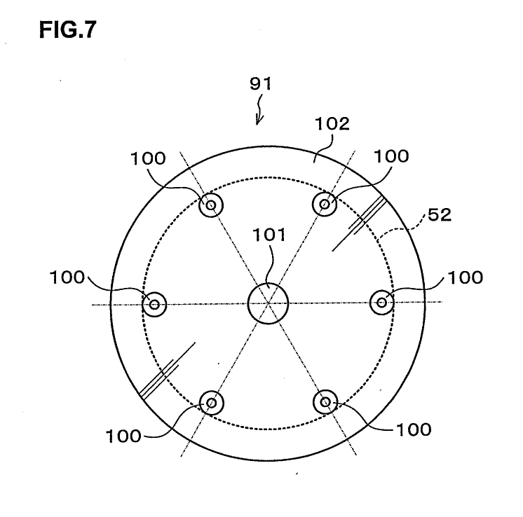

The first vertical moving part 91 has a plurality of, for example, six cylinders 100 moving the outer peripheral portion of the third holding part 52 annularly in the vertical direction, a supporting post 101 supporting the central portion of the third holding part 52, and a supporting plate 102 supporting the cylinders 100 and the supporting post 101. As illustrated in FIG. 7, the six cylinders 100 are arranged at regular intervals on the same circumference as the supporting plate 102. Further, the cylinders 100 are arranged at positions corresponding to the outer peripheral portion of the third holding part 52. The supporting post 101 is arranged at a position corresponding to the central portion of the supporting plate 102 and the central portion of the third holding part 52. In other words, the supporting post 101 is arranged so that the position in the vertical direction of the central portion of the third holding part 52 is not changed when the cylinders 100 move the outer peripheral portion of the third holding part 52 vertically downward.

The second vertical moving part 92 has a drive part 110 raising and lowering the supporting plate 102 and supporting members 111 supporting the supporting plate 102 as illustrated ion FIG. 4. The drive part 110 has, for example, a ball screw (not illustrated) and a motor (not illustrated) turning the ball screw. Further, the supporting members 111 are configured to expand and contract in the vertical direction and provided at, for example, three positions between the supporting plate 102 and the horizontal moving part 93.

The horizontal moving part 93 has, for example, a ball screw (not illustrated) and a motor (not illustrated) turning the ball screw, and can move the first vertical moving part 91, the second vertical moving part 92, and the third holding part 52 in the horizontal direction.

Note that below the third holding part 52, raising and lowering pins (not illustrated) for supporting the superposed wafer T or the supporting wafer S from below and raising and lowering it are provided. The raising and lowering pins pass through through holes (not illustrated) formed in the third holding part 52 and can project from the upper surface of the third holding part 52.

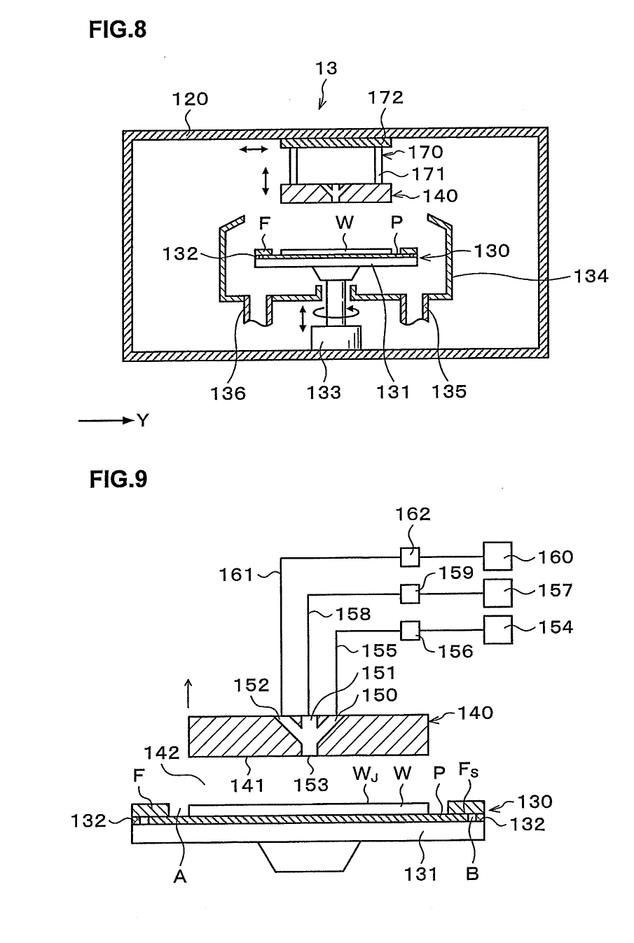

Next, the configuration of the above-described cleaning apparatus 13 will be described. The cleaning apparatus 13 has a treatment container 120 as illustrated in FIG. 8. In a side surface of the treatment container 120, a transfer-in/out port (not illustrated) for the processing target wafer W is formed, and an opening/closing shutter (not illustrated) is provided at the transfer-in/out port. Note that a filter (not illustrated) for clarifying the inner atmosphere is provided in the treatment container 120. The processing target wafer W is held by the dicing frame F and a dicing tape P.

At the central portion inside the treatment container 120, a wafer holding part 130 as a substrate holding part is provided. The wafer holding part 130 has a spin chuck 131 as a first holding part holding and rotating the processing target wafer W via the dicing pate P, and a suction pad 132 as a second holding part suction-holding the surface F_{S} of the dicing frame F as illustrated in FIG. 9.

The spin chuck 131 has a horizontal upper surface, and a suction port (not illustrated) sucking, for example, the dicing tape P is provided in the upper surface. Further, the spin chuck 131 is provided to cover at least the processing target wafer W. By suction through the suction port, the processing target wafer W can be suction-held on the spin chuck 131 via the dicing tape P. Further, the processing target wafer W is suction-held on the spin chuck 131 such that the joint surface W_{J} thereof is directed upward.

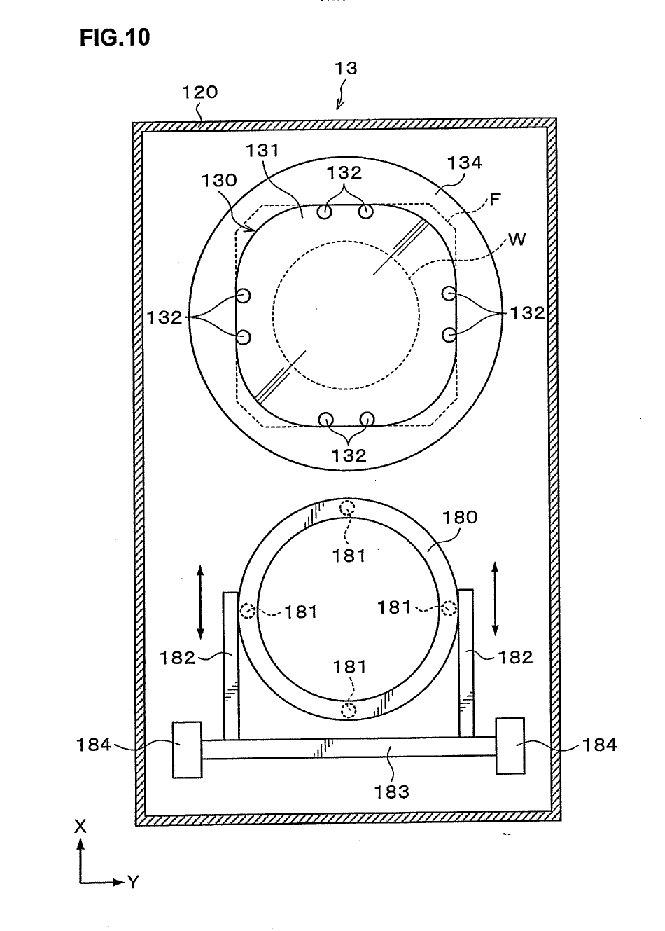

The suction pad 132 is provided on the outer peripheral portion of the spin chuck 131. In other words, the suction pad 132 is arranged outside the dicing tape P. Further, to the suction pad 132, a negative pressure generating device (not illustrated) such as, for example, a vacuum pump is connected so that the suction pad 132 can suction-hold the surface F_{S} of the dicing frame F outside the dicing tape P. Note that the suction pad 132 is provided at a plurality of position, for example, eight positions as illustrated in FIG. 10.

Here, at the outer peripheral portion of the dicing frame F, the step B exists outside the dicing tape P as illustrated in FIG. 9 as described above. Therefore, when the spin chuck 131 tries to suction-hold the dicing frame F, a gap due to the step B is generated between the spin chuck 131 and the dicing frame F. In other words, the spin chuck 131 cannot directly suction-hold the dicing frame F. In this case, since the dicing frame F is not fixed, the processing target wafer W is not appropriately held by the spin chuck 131. In this regard, the dicing frame F is suction-held by the suction pads 132 in this embodiment, so that the processing target wafer W is also appropriately held by the wafer holding part 130.

Below the wafer holding part 130, a chuck drive part 133 as a rotation mechanism equipped with, for example, a motor is provided as illustrated in FIG. 8. The spin chuck 131 can rotate at a predetermined speed by means of the chuck drive part 133. Further, the chuck drive part 133 is provided with a raising and lowering drive source such as, for example, a cylinder so that the spin chuck 131 can freely rise and lower.

Around the wafer holding part 130, a cup 134 is provided which receives and collects liquid splashing or dropping from the processing target wafer W. A drain pipe 135 draining the collected liquid and an exhaust pipe 136 evacuating and exhausting the atmosphere in the cup 134 are connected to the lower surface of the cup 134.

Above the wafer holding part 130, a cleaning jig 140 is provided for cleaning the joint surface W_{J} of the processing target wafer W. The cleaning jig 140 is placed to face the processing target wafer W held on the wafer holding part 130.

The cleaning jig 140 has an almost disc shape as illustrated in FIG. 9. At the lower surface of the cleaning jig 140, a supply surface 141 is formed to cover the joint surface W_{J} of the processing target wafer W. Note that the supply surface 141 and the joint surface W_{J} have substantially the same size in this embodiment.

At the central portion of the cleaning jig 140, a solvent supply part 150 supplying a solvent for the adhesive G, for example, a thinner to a gap 142 between the supply surface 141 and the joint surface W_{J}, a rinse solution supply part 151 supplying a rinse solution for the solvent to the gap 142, and an inert gas supply part 152 supplying an inert gas, for example, a nitrogen gas to the gap 142 are provided. The solvent supply part 150, the rinse solution supply part 151, and the inert gas supply part 152 join together inside the cleaning jig 140 and communicate with a supply port 153 formed in the supply surface 141 of the cleaning jig 140. In other words, the flow path from the solvent supply part 150 to the supply port 153, the flow path from the rinse solution supply part 151 to the supply port 153, and the flow path from the inert gas supply part 152 to the supply port 153 penetrate the cleaning jig 140 in the thickness direction thereof. Note that, for the rinse solution, various kinds of liquids according to the component of a main solvent of the adhesive G are used, and pure water or IPA (isopropyl alcohol) is used. Further, it is preferable to use highly-volatile liquid as the rinse solution in order to accelerate drying of the rinse solution.

To the solvent supply part 150, a supply pipe 155 is connected which communicates with a solvent supply source 154 storing a solvent therein. Along the supply pipe 155, a supply equipment group 156 is provided which includes a valve, a flow regulator and so on for controlling the flow of the solvent. To the rinse solution supply part 151, a supply pipe 158 is connected which communicates with a rinse solution supply source 157 storing the rinse solution therein. Along the supply pipe 158, a supply equipment group 159 is provided which includes a valve, a flow regulator and so on for controlling the flow of the rinse solution. To the inert gas supply part 152, a supply pipe 161 is connected which communicates with an inert gas supply source 160 storing the inert gas therein. Along the supply pipe 161, a supply equipment group 162 is provided which includes a valve, a flow regulator and so on for controlling the flow of the inert gas.

At the ceiling surface of the treatment container 120 and above the cleaning jig 140, a moving mechanism 170 moving the leaning jig 140 in the vertical direction and the horizontal direction is provided as illustrated in

FIG. 8. The moving mechanism 170 has a supporting member 171 supporting the cleaning jig 140, and a jig drive part 172 for supporting the supporting member 171 and moving the cleaning jig 140 in the vertical direction and the horizontal direction.

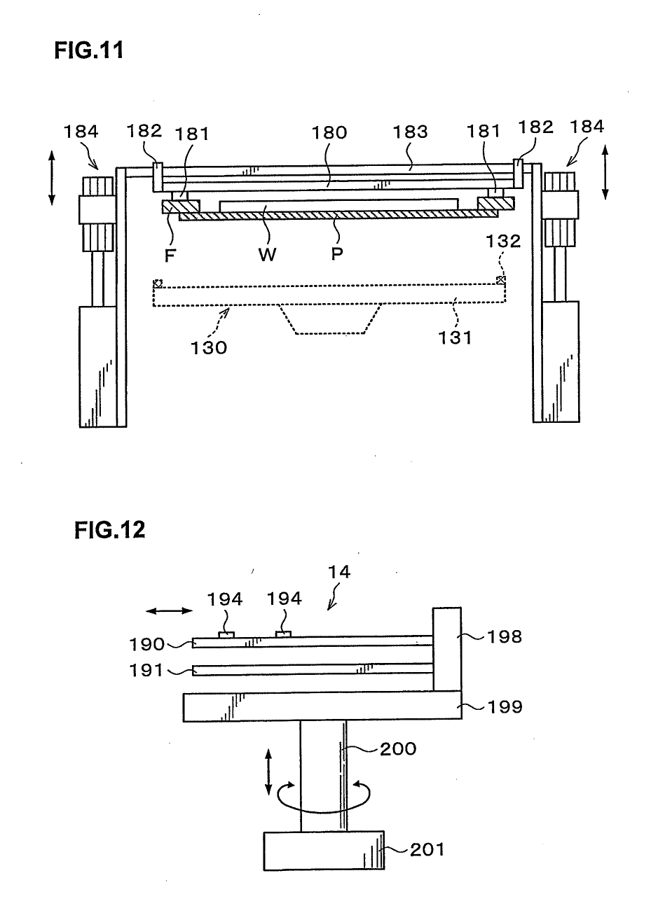

Inside the treatment container 120, a delivery arm 180 is provided for delivering the processing target wafer W from the transfer apparatus 14 to the wafer holding part 130 as illustrated in FIG. 10 and FIG. 11. The delivery arm 180 has an annular shape to be able to hold the outer peripheral portion of the dicing frame F. At the lower surface of the delivery arm 180, a frame holding part 181 is provided at a plurality of positions, for example, four positions. To the frame holding parts 181, a negative pressure generating device (not illustrated) such as, for example, a vacuum pump is connected so that the frame holding parts 181 can suction-hold the dicing frame F to which the processing target wafer W is attached.

The delivery arm 180 is supported by a pair of expansion and contraction members 182, 182. The expansion and contraction members 182 are configure to freely expand and contract in the horizontal direction (an X-direction in FIG. 10). Further, the expansion and contraction members 182 are supported by a supporting member 183 extending in a Y-direction in FIG. 10. At both end portions of the supporting member 183, raising and lowering mechanisms 184 are provided which raise and lower the supporting member 183 in the vertical direction. As the raising and lowering mechanisms 184, for example, cylinders or the like are used. This configuration allows the delivery arm 180 to be movable in the horizontal direction and to freely rise and lower in the vertical direction.

Next, the configuration of the above-described transfer apparatus 14 will be described. The transfer apparatus 14 has a first transfer arm 190 holding and transferring the superposed wafer T or the processing target wafer W, and a second transfer arm 191 holding and transferring the supporting wafer S as illustrated in FIG. 12. Note that each of the superposed wafer T and the processing target wafer W transferred by the first transfer arm 190 is held by the dicing frame F and the dicing tape P.

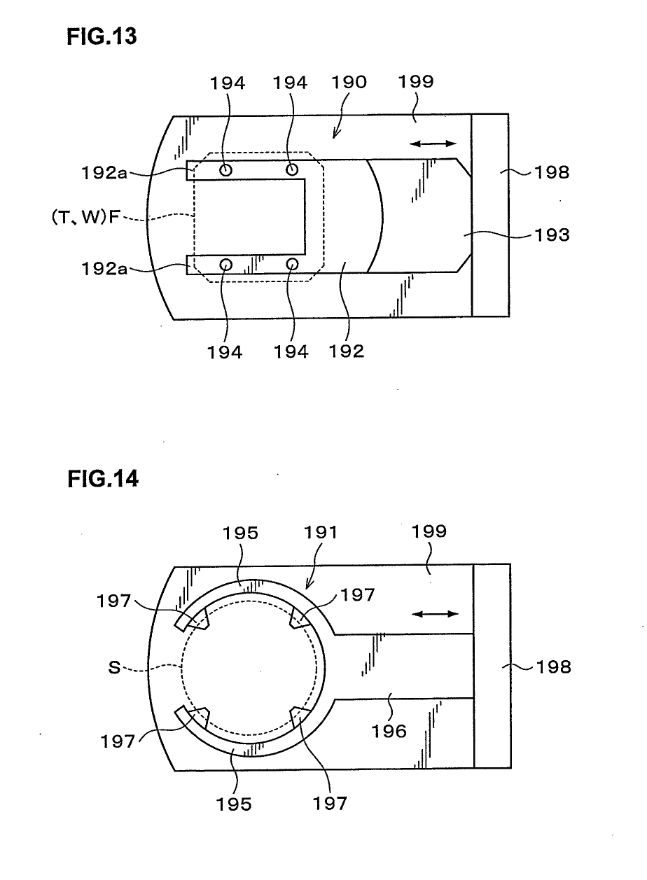

The first transfer arm 190 has an arm part 192 having a tip branched off into two tip end portions 192a, 192a, and a supporting part 193 formed integrally with the arm part 192 and supporting the arm part 192 as illustrated in FIG. 13. At each of the tip end portions 192a of the arm part 192, suction pads 194 sucking and holding the superposed wafer T or the processing target wafer W via the dicing frame F or the dicing tape P are provided. The first transfer arm 190 can horizontally hold the superposed wafer T or the processing target wafer W on the arm part 192.

The second transfer arm 191 has an arm part 195 configured in an almost ¾ circular ring shape larger than the supporting wafer S and a supporting part 196 formed integrally with the arm part 195 and supporting the arm part 195 as shown in FIG. 14. At the arm part 195, a holding part 197 projecting inward and holding the peripheral portion of the supporting wafer S is provided at, for example, four positions. The second transfer arm 191 can horizontally hold the supporting wafer S on the holding parts 197.

At the base end portions of the transfer arms 190, 191, an arm drive part 198 is provided as illustrated in FIG. 12. By means of the arm drive part 198, each of the transfer arms 190, 191 can independently move in the horizontal direction. The transfer arms 190, 191 and the arm drive part 198 are supported on a base 199. On the lower surface of the base 199, a rotation drive part 201 is provided via a shaft 200. By means of the rotation drive part 201, the base 199 and the transfer arms 190, 191 can rotate around the shaft 200 as a center axis and rise and lower.

In the above separation system 1, a control unit 250 is provided as illustrated in FIG. 1. The control unit 250 is, for example, a computer and has a program storage part (not illustrated). In the program storage part, a program is stored which controls the processing of the processing target wafer W, the supporting wafer S, and the superposed wafer T in the separation system 1. Further, the program storage part also stores a program for controlling the operation of the driving system of the above-described various processing and treatment apparatuses and transfer apparatuses to implement the later-described separation processing in the separation system 1. Note that the programs may be the ones which are stored, for example, in a non-transitory computer-readable storage medium H such as a computer-readable hard disk (HD), flexible disk (FD), compact disk (CD), magneto-optical disk (MO), or memory card, and installed from the storage medium H into the control unit 250.

Next, the separation processing method for the processing target wafer W and the supporting wafer S performed using the separation system 1 configured as described above will be described.

First, a cassette C_{T} housing a plurality of superposed wafers T and an empty cassette C_{W} are mounted on the predetermined cassette mounting plates 21 in the first transfer-in/out station 10. Further, an empty cassette C_{S} is mounted on the predetermined cassette mounting plate 31 in the second transfer-in/out station 11. Then, a superposed wafer T in the cassette C_{T} is taken out by the first transfer arm 190 of the transfer apparatus 14 and transferred to the separation apparatus 12. In this event, the superposed wafer T is held by the dicing frame F and the dicing tape P, and transferred with the processing target wafer W placed on the upper side and the supporting wafer S placed on the lower side.

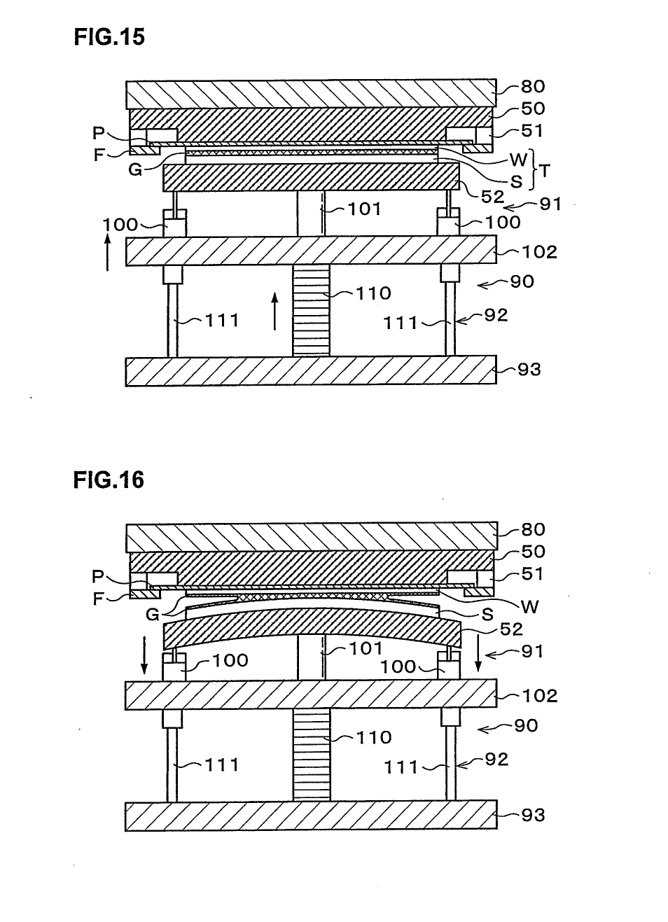

The superposed wafer T transferred in the separation apparatus 12 is suction-held by the third holding part 52. Thereafter, the third holding part 52 is raised by the second vertical moving part 92 of the moving mechanism 90 so that the superposed wafer T is held by and sandwiched between the first holding part 50 and the third holding part 52 as illustrated in FIG. 15. In this event, the non-joint surface W_{N} of the processing target wafer W is suction-held by the first holding part 50 via the dicing tape P, the surface F_{S} of the dicing frame F is suction-held by the second holding part 51, and the non-joint surface S_{N} of the supporting wafer S is suction-held by the third holding part 52.

Thereafter, the heating mechanisms 61, 71 heat the superposed wafer T to a predetermine temperature, for example, 200° C. Then, the adhesive G in the superposed wafer T becomes softened.

Subsequently, while the heating mechanisms 61, 71 are heating the superposed wafer T to keep the adhesive G in the softened state, the first vertical moving part 91 of the moving mechanism 90 moves only the outer peripheral portion of the third holding part 52 annularly and vertically downward as illustrated in FIG. 16. In other words, when the cylinders 100 move the outer peripheral portion of the third holding part 52 vertically downward, the central portion of the third holding part 52 is supported by the supporting post 101 so that the position in the vertical direction of the central portion of the third holding part 52 does not change.

In this case, the supporting wafer S held by the third holding part 52 is continuously separated from the processing target wafer W supported by the first holding part 50 and the second holding part 51 starting from the outer peripheral portion toward the central portion. Here, the electronic circuits are formed on the joint surface W_{J} of the processing target wafer W as described above, so that if it is tried to separate the processing target wafer W and the supporting wafer S at once, a great load may be applied on the joint surfaces W_{J}, S_{J} to cause damage to the electronic circuits on the joint surface W_{J}. In this regard, the supporting wafer S is continuously separated from the processing target wafer W starting from the outer peripheral portion toward the central portion in this embodiment, any great load is not applied on the joint surfaces W_{J}, S_{J}. Accordingly, it is possible to suppress the damage to the electronic circuits.

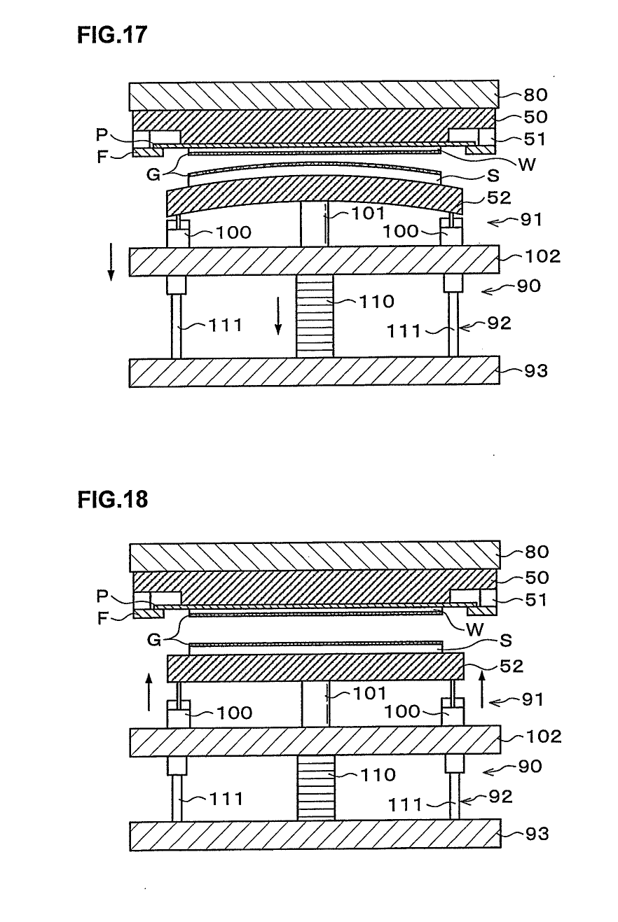

Thereafter, with only the central portion of the processing target wafer W and the central portion of the supporting wafer S adhering with each other, the second vertical moving part 92 moves the whole third holding part 52 vertically downward as illustrated in FIG. 17. Then, the supporting wafer S is separated from the processing target wafer W with the outer peripheral portion of the supporting wafer S bent vertically downward. Thereafter, the first vertical moving part 91 moves the outer peripheral portions of the third holding part 52 and the supporting wafer S vertically upward as illustrated in FIG. 18 so that the third holding part 52 and the supporting wafer S are flattened. Thus, the processing target wafer W held by the first holding part 50 and the second holding part 51 and the supporting wafer S held by the third holding part 52 are separated from each other.

The processing target wafer W separated in the separation apparatus 12 is then transferred by the first transfer arm 190 of the transfer apparatus 14 to the reversing apparatus 32, and the front and rear surfaces of the processing target wafer W are reversed in the reversing apparatus 32. In short, the joint surface W_{J} of the processing target wafer W is directed upward. Thereafter, the processing target wafer W is transferred by the first transfer arm 190 of the transfer apparatus 14 to the cleaning apparatus 13. Note that the processing target wafer W transferred out of the separation apparatus 12 into the cleaning apparatus 13 is held by the dicing frame F and the dicing tape P.

On the other hand, the supporting wafer S separated in the separation apparatus 12 is transferred by the second transfer arm 191 of the transfer apparatus 14 to the cassette C_{S} in the second transfer-in/out station 11. The supporting wafer S is then transferred from the second transfer-in/out station 11 to the outside and collected. Note that the timing when the supporting wafer S is transferred to the second transfer-in/out station 11 can be arbitrarily set. The transfer of the supporting wafer S may be before the processing target wafer W is transferred to the reversing apparatus 32, may be during the time when the front and rear surfaces of the processing target wafer W are reversed in the reversing apparatus 32, or may be after the processing target wafer W is transferred to the cleaning apparatus 13.

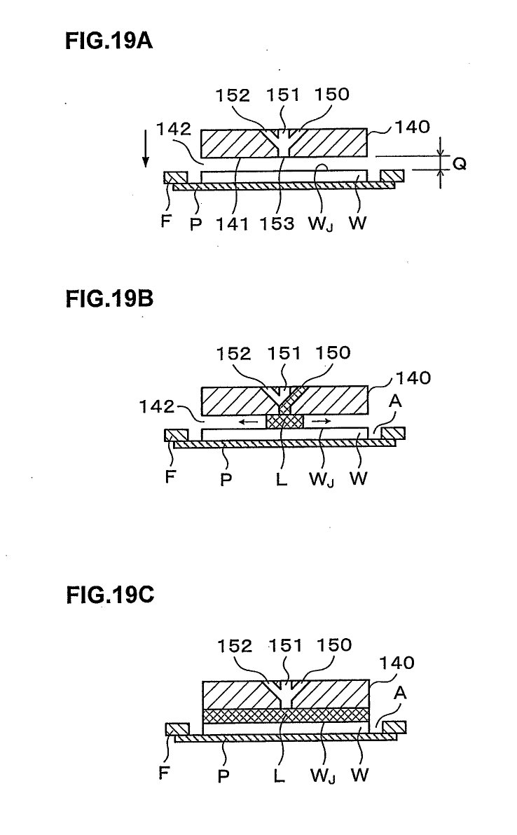

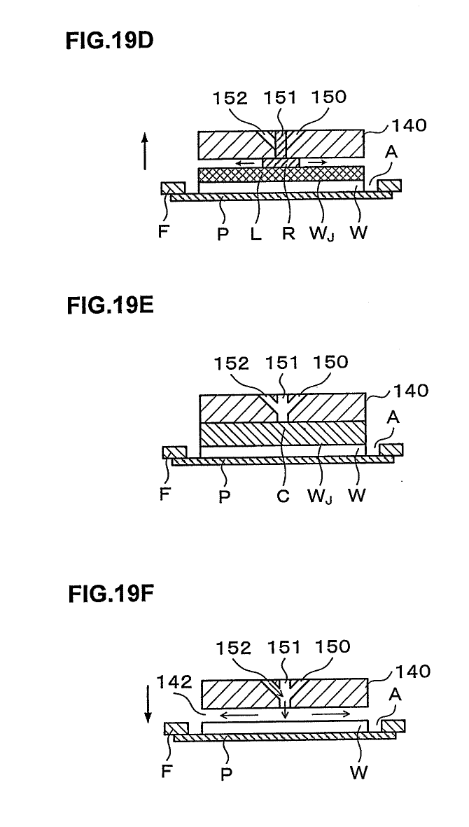

The processing target wafer W transferred into the cleaning apparatus 13 is delivered from the first transfer arm 190 of the transfer apparatus 14 to the delivery arm 180. Subsequently, the processing target wafer W is delivered by the delivery arm 180 to the wafer holding part 130 and held by the wafer holding part 130. Concretely, the processing target wafer W is suction-held on the spin chuck 131 via the dicing tape P. Concurrently, the surface F_{S} of the dicing frame F is suction-held by the suction pads 132. Subsequently, the position in the horizontal direction of the cleaning jig 140 is adjusted by the moving mechanism 170, and the cleaning jig 140 is lowered down to a predetermined position as illustrated in FIG. 19A. In this event, a predetermined distance Q between the supply surface 141 of the cleaning jig 140 and the joint surface W_{J} of the processing target wafer W is the distance allowing the solvent for the adhesive G to diffuse by the surface tension in the gap 142 between the supply surface 141 and the joint surface W_{J} as will be described later.

Thereafter, while the spin chuck 131 is rotating the processing target wafer W, the solvent L is supplied from the solvent supply source 154 to the solvent supply part 150 as illustrated in FIG. 19B. The solvent L is supplied from the supply port 153 to the gap 142 between the supply surface 141 and the joint surface W_{J}, and diffuses on the joint surface W_{J} of the processing target wafer W by the surface tension of the solvent L and the centrifugal force by the rotation of the processing target wafer W in the gap 142. Thus, the solvent L is supplied on the entire joint surface W_{J} of the processing target wafer W in the gap 142 as illustrated in FIG. 19C.

Thereafter, the state in which the joint surface W_{J} of the processing target wafer W is immersed in the solvent L is maintained for a predetermined time, for example, several minutes. Thus, the solvent L removes the impurities such as the adhesive G remaining on the joint surface W_{J}.

Thereafter, in the state that the rotation of the processing target wafer W is being continuously performed by the spin chuck 131, the cleaning jig 140 is raised up to a predetermined position, that is, the position where the rinse solution R can be supplied to the gap 142 as illustrated in FIG. 19D. Subsequently, the rinse solution R is supplied from the rinse solution supply source 157 to the rinse solution supply part 151. The rinse solution R is supplied from the supply port 153 to the gap 142, and diffuses on the joint surface W_{J} of the processing target wafer W by the surface tension and the centrifugal force in the gap 142 while being mixed with the solvent L. Thus, a mixed solution C of the solvent L and rinse solution R is supplied on the entire joint surface W_{J} of the processing target wafer W in the gap 142 as illustrated in FIG. 19E.

Thereafter, in the state that the rotation of the processing target wafer W is being continuously performed by the spin chuck 131, the cleaning jig 140 is lowered to a predetermined position as illustrated in FIG. 19F. Then, the inert gas is supplied to the gap 142 from the inert gas supply source 160 via the inert gas supply part 152 and the supply port 153. The inert gas pushes away the mixed solution C filled in the gap 142 to the outside of the gap 142. In this manner, the mixed solution C in the gap 142 is removed.

Note that the reason why the cleaning jig 140 is lowered when supplying the inert gas to the gap 142 as described above is to decrease the distance in the vertical direction of the gap 142 to increase the flow velocity of the inert gas. This enables quick removal of the mixed solution C in the gap 142. Further, the mixed solution C pushed away by the inert gas can flow onto the dicing tape P at a stepped portion A between the processing target wafer W and the dicing frame F but, also in this case, the dicing tape P is never damaged because the solvent L in the mixed solution C has been diluted.

Also after the mixed solution C in the gap 142 is removed, the rotation of the processing target wafer W by the spin chuck 131 and the supply of the inert gas to the gap 142 are continuously performed. Then, the joint surface W_{J} of the processing target wafer W is dried. Thus, the joint surface W_{J} of the processing target wafer W is cleaned in the cleaning apparatus 13.

Thereafter, the processing target wafer W cleaned in the cleaning apparatus 13 is transferred by the first transfer arm 190 of the transfer apparatus 14 to the cassette C_{W} in the first transfer-in/out station 10. Thereafter, the processing target wafer W is transferred from the first transfer-in/out station 10 to the outside and collected. Thus, a series of separation processing of the processing target wafer W and the supporting wafer S in the separation system 1 ends.

According to the cleaning apparatus 13 in the above embodiment, the solvent L for the adhesive G supplied to the gap 142 between the supply surface 141 of the cleaning jig 140 and the joint surface W_{J} of the processing target wafer W diffuses in the gap 142 by the surface tension of the solvent L and the centrifugal force generated by the rotation of the processing target wafer W. In this event, the solvent L can efficiently diffuse in the gap 142 because the two external forces being the surface tension and the centrifugal force are applied thereto. Further, the solvent L diffuses only on the joint surface W_{J} of the processing target wafer W and never flows onto the dicing tape P at the stepped portion A between the processing target wafer W and the dicing frame F. Accordingly, while suppressing the damage to the dicing tape P due to the solvent L, the joint surface W_{J} of the processing target wafer W can be appropriately cleaned. Further, since the solvent L never diffuses outside the joint surface W_{J} of the processing target wafer W in this embodiment, the supply amount of the solvent L can be suppressed to be small, so that the cost of the solvent L can be reduced.

Further, when cleaning the joint surface W_{J} of the processing target wafer W, the rinse solution R is supplied to the gap 142 after the solvent L is supplied to the gap 142, so that the rinse solution R can remove the adhesive G on the joint surface W_{J}, to appropriately clean the joint surface W_{J} of the processing target wafer W. Further, since the solvent L is diluted with the rinse solution R in the gap 142, it is possible to suppress the damage to the dicing tape P even if the mixed solution C of the solvent L and the rinse solution R flows onto the dicing tape P at the stepped portion A between the processing target wafer W and the dicing frame F.

Further, when cleaning the joint surface W_{J} of the processing target wafer W, the inert gas is supplied to the gap 142 after the rinse solution R is supplied to the gap 142, and therefore can appropriately dry the joint surface W_{J} of the processing target wafer W.

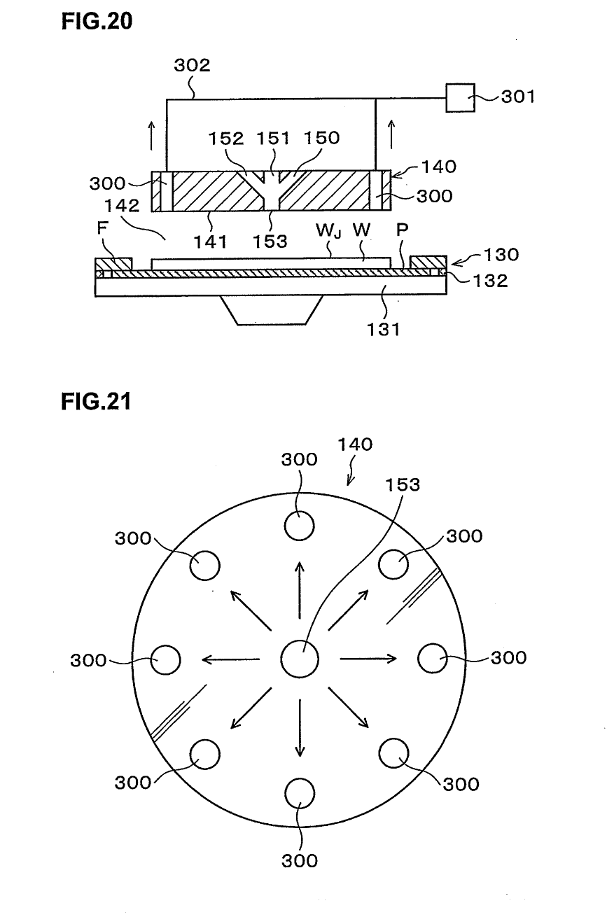

At the outer peripheral portion of the cleaning jig 140 in the above embodiment, a suction part 300 may be provided for sucking the solvent L and the mixed solution C in the gap 142 between the supply surface 141 and the joint surface W_{J} as illustrated in FIG. 20 and FIG. 21. The suction part 300 is provided penetrating the cleaning jig 140 in the thickness direction thereof. Further, the suction part 300 is provided at a plurality of, for example, eight positions at regular intervals on the same circumference as the cleaning jig 140. To each of the suction parts 300, a suction pipe 302 is connected which communicates with a negative pressure generating device 301 such as, for example, a vacuum pump. Note that the other configuration of the cleaning jig 140 is the same as the configuration of the cleaning jig 140 in the above embodiment, and therefore the description thereof will be omitted. Further, the shapes and the arrangement of the supply port 153 and the suction parts 300 of the cleaning jig 140 are not limited to this embodiment, but can employ various aspects. For example, the supply port 153 and the suction part 300 may have an elongated shape in a slit form in a plan view.

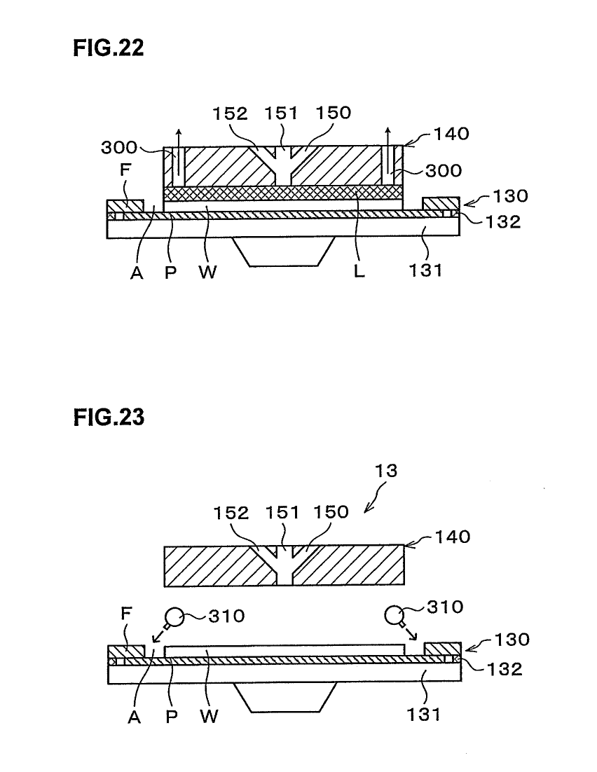

In this case, when the solvent L is supplied from the supply port 153 to the gap 142 between the supply surface 141 and the joint surface W_{J} via the solvent supply part 150 as illustrated in FIG. 22, suction of the solvent L in the gap 142 is performed by the suction parts 300. Then, the solvent L never flows onto the dicing tape P at the stepped portion A between the processing target wafer W and the dicing frame F. Thereafter, also when the rinse solution R is supplied and the inert gas is supplied to the gap 142, the suction by the suction parts 300 is continuously performed. This also avoids the mixed solution C of the solvent L and the rinse solution R from flowing onto the dicing tape P at the stepped portion A. Accordingly, it is possible to surely prevent the solvent L and the mixed solution C from flowing onto the dicing tape P at the stepped portion A between the processing target wafer W and the dicing frame F, and thus suppress the damage to the dicing tape P in this embodiment.

Once the solvent L or the mixed solution C flows into the stepped portion A, the solvent L or the mixed solution C is difficult to flow out of the stepped portion A. Therefore, it is difficult to dry the stepped portion A and it takes time to clean the joint surface W_{J} of the processing target wafer W. In this regard, the solvent L and the mixed solution C never flow into the stepped portion A in this embodiment, it is possible to quickly clean the joint surface W_{J}.

Note that the method of preventing the solvent L and the mixed solution C from flowing into the stepped portion A is not limited to this embodiment, but various methods can be employed. For example, the cleaning apparatus 13 may have a gas supply part 310 supplying gas, for example, a drying gas or an inert gas to the stepped portion A as illustrated in FIG. 23. In this case, when cleaning the joint surface W_{J} of the processing target wafer W, supplying the gas from the gas supply part 310 while the spin chuck 131 is rotating the processing target wafer W makes it possible to prevent the solvent L and the mixed solution C from flowing into the stepped portion A. Accordingly, it is possible to suppress the damage to the dicing tape P and to quickly clean the joint surface W_{J}. Note that a plurality of gas supply parts 310 may be provided as in the illustrated example.

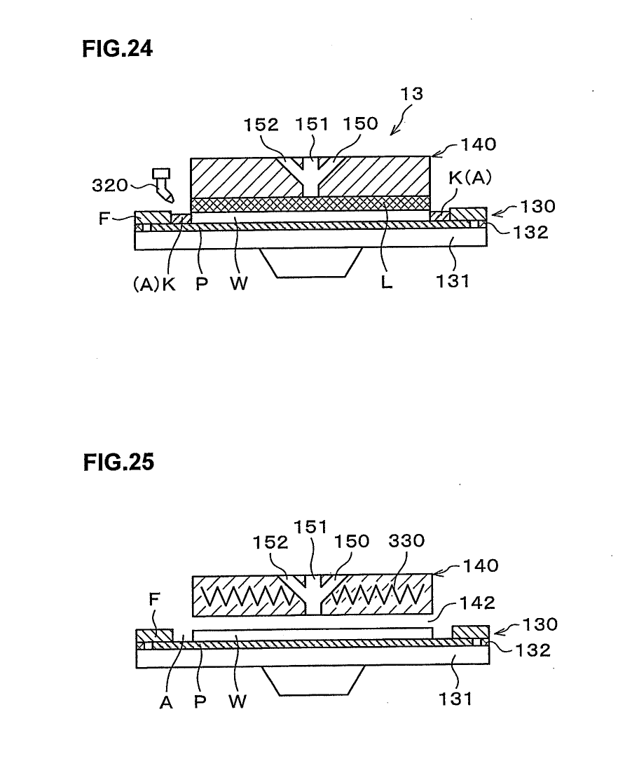

Further, the cleaning apparatus 13 may have a filler solution supply part 320 supplying a filler solution K to the stepped portion A, for example, as illustrated in FIG. 24. A material not damaging the dicing tape P is used as the filler solution K and determined according to the kind of the dicing tape P. Further, it is preferable to use a highly-volatile solution as the filler solution K in order to accelerate the drying of the stepped portion A after the cleaning of the processing target wafer W. In this case, when cleaning the joint surface W_{J} of the processing target wafer W, the stepped portion A is filled with the filler solution K from the filler solution supply part 320 while the spin chuck 131 is rotating the processing target wafer W. Thus, if the solvent L or the mixed solution C flows to the outside of the joint surface W_{J} of the processing target wafer W, the solvent L or the mixed solution C is diluted with the filler solution K in the stepped portion A. Accordingly, the damage to the dicing tape P can be suppressed.

Inside the cleaning jig 140 in the above embodiment, a heating mechanism 330 may be provided as illustrated in FIG. 25. As the heating mechanism 330, for example, a heater is used. In this case, after the joint surface W_{J} of the processing target wafer W is cleaned and the mixed solution C in the gap 142 is removed by the inert gas, the cleaning jig 140 is heated by the heating mechanism 330 when the joint surface W_{J} is dried. Then, the heat is conducted to the joint surface W_{J} and can quickly dry the joint surface W_{J}. Note that the heating mechanism 330 may be provided outside the cleaning jig 140.

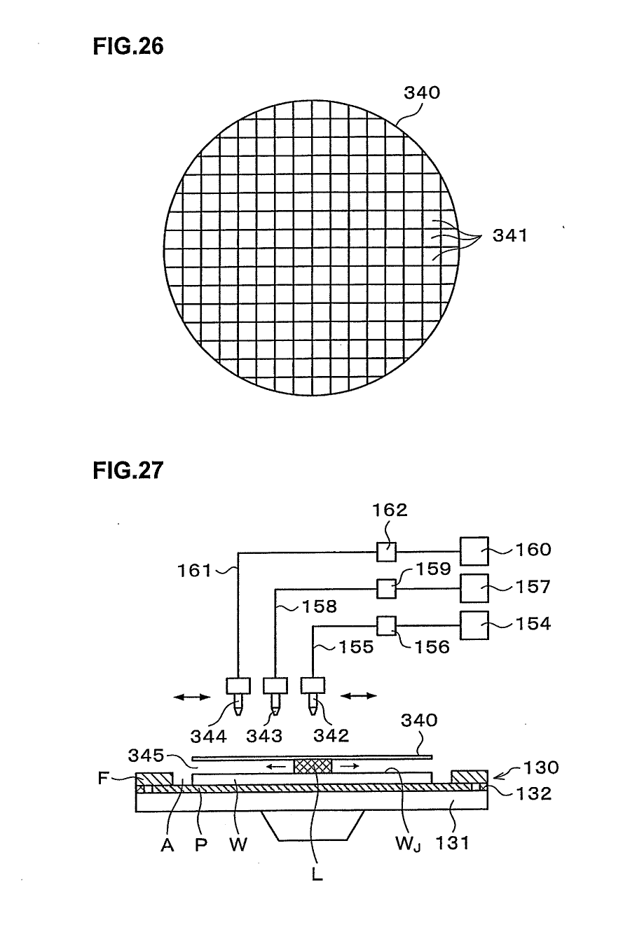

Though the cleaning jig 140 in the above embodiment has an almost flat plate shape, a mesh plate 340 may be used as the cleaning jig as illustrated in FIG. 26. The mesh plate 340 has a size covering at least the joint surface W_{J} of the processing target wafer W, and the mesh plate 340 and the processing target wafer W are substantially the same size in this embodiment. Further, a plurality of openings 341 are formed in the mesh plate 340.

In this case, in place of the solvent supply part 150, the rinse solution supply part 151, and the inert gas supply part 152 formed inside the cleaning jig 140, a solvent nozzle 342 as the solvent supply part, a rinse solution nozzle 343 as the rinse solution supply part, and an inert gas nozzle 344 as the inert gas supply part are used respectively as illustrated in FIG. 27. The solvent nozzle 342, the rinse solution nozzle 343, and the inert gas nozzle 344 are arranged above the mesh plate 340. To the solvent nozzle 342, the supply pipe 155 is connected which communicates with the above-described solvent supply source 154. To the rinse solution nozzle 343, the supply pipe 158 is connected which communicates with the above-described rinse solution supply source 157. To the inert gas nozzle 344, the supply pipe 161 is connected which communicates with the above-described inert gas supply source 160. Note that though the solvent nozzle 342, the rinse solution nozzle 343, and the inert gas nozzle 344 are separately provided in this embodiment, the solvent L, the rinse solution R, and the inert gas may be supplied from one nozzle.

When cleaning the joint surface W_{J} of the processing target wafer W, the solvent L is supplied to a gap 345 between the mesh plate 340 and the joint surface W_{J} while the spin chuck 131 is rotating the processing target wafer W, and the solvent L diffuses on the joint surface W_{J} by the surface tension and the centrifugal force in the gap 345. In this event, because of use of the mesh plate 340, the surface tension is great to easily form the state that the joint surface W_{J} is immersed in the solvent L. Thereafter, the rinse solution R is supplied from the rinse solution nozzle 343 to the gap 345, and the rinse solution R diffuses on the joint surface W_{J} of the processing target wafer W by the surface tension and the centrifugal force in the gap 345 while being mixed with the solvent L. Thereafter, the inert gas is supplied from the inert gas nozzle 344 to the gap 345, and the inert gas removes the mixed solution C in the gap 345 to further dry the joint surface W_{J}. In this manner, the joint surface W_{J} of the processing target wafer W can be appropriately cleaned also in this embodiment.

Note that when using the mesh plate 340 as in this embodiment, a suction part (not illustrated) for sucking the solvent L and the mixed solution C in the gap 345 may be provided. As the suction part, for example, a scan nozzle movable in the radial direction of the processing target wafer W is used.

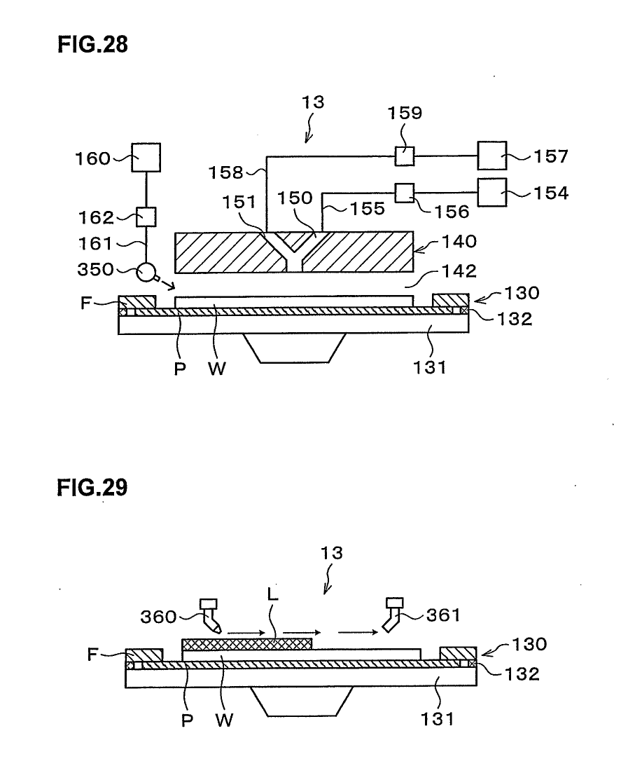

Though the solvent supply part 150, the rinse solution supply part 151, and the inert gas supply part 152 are formed inside the cleaning jig 140 of the above embodiment, the solvent supply part, the rinse solution supply part, and the inert gas supply part may employ various aspects. For example, the solvent supply part 150 and the rinse solution supply part 151 may be provided inside the cleaning jig 140, and an inert gas supply part 350 supplying the inert gas to the gap 142 may be provided outside the cleaning jig 140 as illustrated in FIG. 28. To the inert gas supply part 350, the supply pipe 161 is connected which communicates with the above-described inert gas supply source 160. Alternatively, all of the solvent supply part, the rinse solution supply part, and the inert gas supply part may be provided outside the cleaning jig 140. In any case, the joint surface W_{J} of the processing target wafer W can be appropriately cleaned.

In the cleaning apparatus 13 in the above embodiment, the cleaning jig 140 may be omitted as illustrated in FIG. 29. In this case, a supply nozzle 360 supplying the solvent L, the rinse solution R, and the inert gas and a suction nozzle 361 sucking the solvent L and the rinse solution R (mixed solution C) are provided above the wafer holding part 130. While the spin chuck 131 is rotating the processing target wafer W, the solvent L, the rinse solution R, and the inert gas are supplied from the supply nozzle 360, and the solvent L and the rinse solution R (mixed solution C) on the processing target wafer W are sucked from the suction nozzle 361. Also in this embodiment, the joint surface W_{J} of the processing target wafer W can be appropriately cleaned.

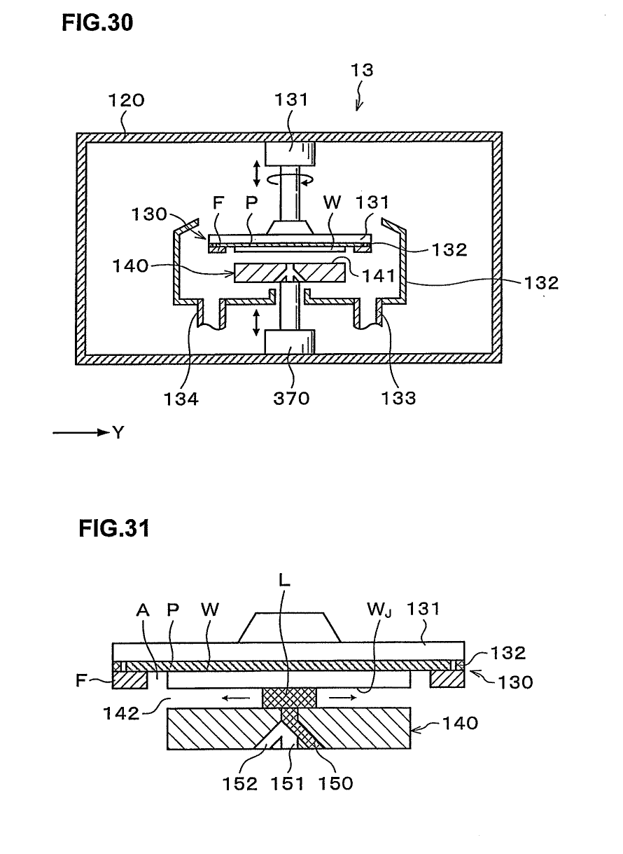

Though the cleaning jig 140 is placed above the wafer holding part 130 in the cleaning apparatus 13 of the above embodiment, the vertical positions of the cleaning jig 140 and the wafer holding part 130 may be reversed as illustrated in FIG. 30. In short, the cleaning jig 140 may be placed below the wafer holding part 130.

In this case, the cleaning jig 140 is placed such that the supply surface 141 is directed upward. Further, below the cleaning jig 140, a jig drive part 370 is provided which includes a raising and lowering drive source such as a motor, a cylinder and the like. The cleaning jig 140 freely rises and lowers by means of the jig drive part 370. Note that the configuration of the cleaning jig 140 is the same as the cleaning jig 140 in the above embodiment and the description thereof will be omitted.

The wafer holding part 130 is placed such that the joint surface W_{J} of the processing target wafer W held by the spin chuck 131 is directed downward. Further, the chuck drive part 133 rotating and raising and lowering the spin chuck 131 is provided above the wafer holding part 130 and attached to the ceiling surface of the treatment container 120.

When cleaning the joint surface W_{J} of the processing target wafer W, the solvent L is supplied from the solvent supply part 150 to the gap 142 between the cleaning jig 140 and the joint surface W_{J} as illustrated in FIG. 31 while the spin chuck 131 is rotating the processing target wafer W, and the solvent L diffuses on the joint surface W_{J} by the surface tension and the centrifugal force in the gap 142. Thereafter, the rinse solution R is supplied from the rinse solution supply part 151 to the gap 142, and the rinse solution R diffuses on the joint surface W_{J} of the processing target wafer W by the surface tension and the centrifugal force in the gap 142 while the rinse solution R is being mixed with the solvent L. Thereafter, the inert gas is supplied from the inert gas supply part 152 to the gap 142, and the inert gas removes the mixed solution C in the gap 142 and dries the joint surface W_{J}. In this event, even if the solvent L or the mixed solution C flows outside the gap 142, the solvent L or the mixed solution C drops downward. In other words, the solvent L and the mixed solution C never flow onto the dicing tape P at the stepped portion A between the processing target wafer W and the dicing frame F. Therefore, it is possible to suppress the damage to the dicing tape P and quickly clean the joint surface W_{J}. Accordingly, even if the vertical positions of the cleaning jig 140 and the wafer holding part 130 are reversed, the joint surface W_{J} of the processing target wafer W can be appropriately cleaned. In addition, since the processing target wafer W is held by the spin chuck 131 such that its joint surface W_{J} is directed downward, the front and rear surfaces of the processing target wafer W separated in the separation apparatus 12 do not need to be reversed. Therefore, the reversing apparatus 32 can be omitted.

Note that the supply of the solvent L and the rinse solution R to the gap 142 may be performed with the joint surface W_{J} directed upward as illustrated in FIG. 19, then the front and rear surfaces of the processing target wafer W may be reversed, and the supply of the inert gas to the gap 142 may be performed with the joint surface W_{J} directed downward as illustrated in FIG. 31. In this case, the impurities on the joint surface W_{J} directed upward are appropriately removed with the solvent L and the rinse solution R. Thereafter, the joint surface W_{J} directed downward is dried with the inert gas, and it is possible to prevent the mixed solution C in the gap 142 from flowing into the stepped portion A in this event.

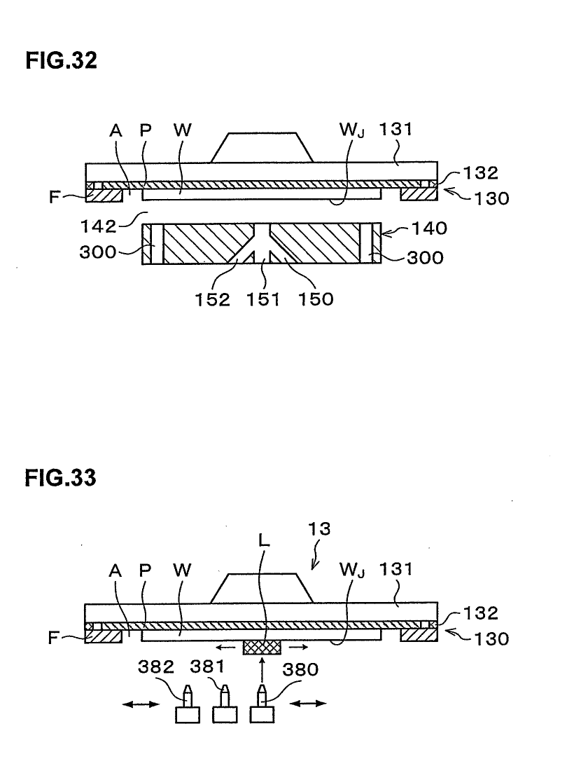

Also in the case where the cleaning jig 140 is placed below the wafer holding part 130 as in the above embodiment, suction parts 300 may be provided at the outer peripheral portion of the cleaning jig 140 as illustrated in FIG. 32. Note that the configuration of the suction part 300 is the same as the configuration of the suction part 300 in the above embodiment and the description thereof will be omitted. In this case, when cleaning the joint surface W_{J} of the processing target wafer W, the solvent L and the mixed solution C in the gap 142 can be sucked from the suction parts 300, thereby making it possible to prevent the solvent L and the mixed solution C from flowing onto the dicing tape P at the stepped portion A between the processing target wafer W and the dicing frame F. In addition, since the solvent L and the mixed solution C are sucked from below the suction parts 300, it is possible to decrease the suction force from the suction parts 300 by the gravity applied on the solvent L and the mixed solution C so as to reduce the load applied on the negative pressure generating device 301.

Further, in the case where the cleaning jig 140 is placed below the wafer holding part 130 in this manner, the cleaning jig 140 may be omitted as illustrated in FIG. 33. In this case, a solvent nozzle 380 supplying the solvent L to the joint surface W_{J} of the processing target wafer W, a rinse solution nozzle 381 supplying the rinse solution R to the joint surface W_{J}, and an inert gas nozzle 382 supplying the inert gas to the joint surface W_{J} are provided below the spin chuck 131. Note that though the solvent nozzle 380, the rinse solution nozzle 381, and the inert gas nozzle 382 are separately provided in this embodiment, the solvent L, the rinse solution R, and the inert gas may be supplied from one nozzle.

When cleaning the joint surface W_{J} of the processing target wafer W, the solvent L is supplied to joint surface W_{J} from the solvent nozzle 380 while the spin chuck 131 is rotating the processing target wafer W, and the solvent L diffuses on the joint surface W_{J} by the centrifugal force. Thereafter, the rinse solution R is supplied from the rinse solution nozzle 381 to the joint surface W_{J}, and the rinse solution R diffuses on the joint surface W_{J} by the centrifugal force while being mixed with the solvent L. Thereafter, the inert gas is supplied from the inert gas nozzle 382 to the joint surface W_{J}, and the inert gas removes the mixed solution C on the joint surface W_{J} and further dries the joint surface W_{J}. In this manner, the joint surface W_{J} of the processing target wafer W can be appropriately cleaned also in this embodiment.

Though the spin chuck 131 rotates the processing target wafer W in the cleaning apparatus 13 in the above embodiment, the cleaning jig 140 may be rotated. In this case, a rotation mechanism (not illustrated) for rotating the cleaning jig 140 is provided in the cleaning apparatus 13. Alternatively, the cleaning jig 140 and the processing target wafer W held by the spin chuck 131 may be rotated together. In any case, relative rotation of the cleaning jig 140 and the processing target wafer W allows the solvent L and the mixed solution C to diffuse on the joint surface W_{J} of the processing target wafer W by the centrifugal force.

Note that the relative rotation of the cleaning jig 140 and the processing target wafer W may be stopped so that the solvent L and the mixed solution C diffuse only by the surface tension.

Though the solvent L, the rinse solution R, and the inert gas are used to clean the joint surface W_{J} of the processing target wafer W in the cleaning apparatus 13 of the above embodiment, the rinse solution R and the inert gas can be omitted, for example, if the solvent L is highly volatile.

The separation processing of the superposed wafer T in the above embodiment may be performed in a separation system different from the separation system 1.

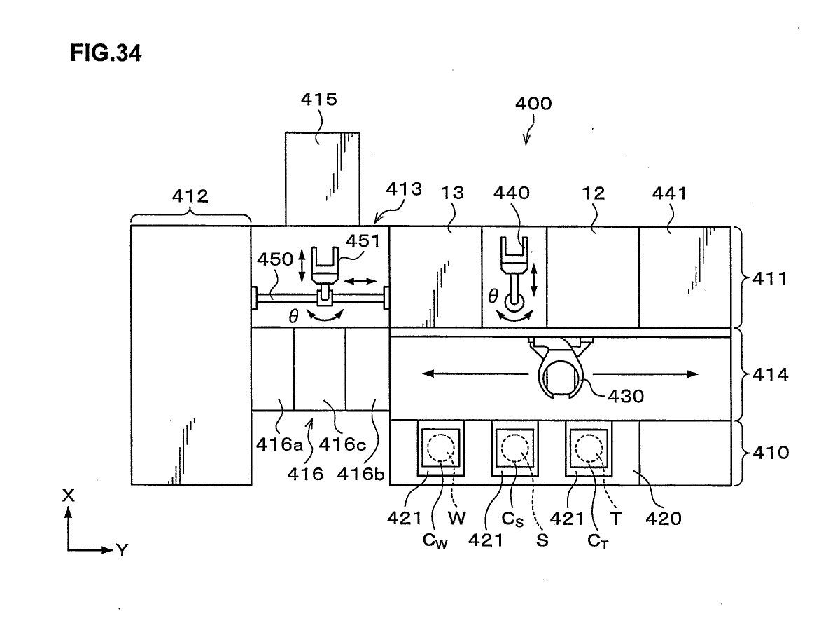

A separation system 400 has, for example, a configuration in which a transfer-in/out station 410 into/from which cassettes C_{W}, C_{S}, C_{T} capable of housing a plurality of processing target wafers W, a plurality of supporting wafers S, and a plurality of superposed wafers T respectively are transferred from/to the outside, a separation processing station 411 including various processing and treatment apparatuses performing predetermined processing and treatment on the processing target wafer W, the supporting wafer S, and the superposed wafer T, and an interface station 413 delivering the processing target wafer W to/from a post-processing station 412 adjacent to the separation processing station 411, are integrally connected as illustrates in FIG. 34. Note that each of the processing target wafer W and the superposed wafer T is held by the dicing frame F and the dicing tape P also in this embodiment.

The transfer-in/out station 410 and the separation processing station 411 are arranged side by side in an X-direction (a top-bottom direction in FIG. 34). Between the transfer-in/out station 410 and the separation processing station 411, a wafer transfer region 414 is formed. The interface station 413 is placed on a Y-direction negative direction side (a left direction side in FIG. 34) of the separation processing station 411. On an X-direction positive direction side (an upper direction side in FIG. 34) of the interface station 413, an inspection apparatus 415 is arranged which inspects the processing target wafer W before transferred to the post-processing station 412. Further, on the opposite side to the inspection apparatus 415 across the interface station 413, that is, on an X-direction negative direction side (a lower direction side in FIG. 34) of the interface station 413, a post-inspection cleaning apparatus 416 is arranged which cleans the processing target wafer W after inspection.

In the transfer-in/out station 410, a cassette mounting table 420 is provided. On the cassette mounting table 420, a plurality of, for example, three cassette mounting plates 421 are provided. The cassette mounting plates 421 are arranged side by side in a line in a Y-direction (a right-left direction in FIG. 34). On these cassette mounting plates 421, the cassettes C_{W}, C_{S}, C_{T} can be mounted when the cassettes C_{W}, C_{S}, C_{T} are transferred in/out from/to the outside of the separation system 400. As described above, the transfer-in/out station 410 is configured to be able to hold the plurality of processing target wafers W, the plurality of the supporting wafers S, and the plurality of superposed wafers T. Further, the number of cassette mounting plates 421 is not limited to this embodiment, but can be arbitrarily determined. Further, the plurality of superposed wafers T transferred into the transfer-in/out station 410 have been subjected to inspection in advance and judged whether they are the superposed wafer T including a normal processing target wafer W or the superposed wafer T including a defective processing target wafer W.

In the wafer transfer region 414, a first transfer apparatus 430 is placed. The first transfer apparatus 430 has, for example, two transfer arms which are movable, for example, in the vertical direction, the horizontal directions (the X-direction, the Y-direction), and around the vertical axis. The two transfer arms have the same configurations as those of the first transfer arm 190 holding and transferring the superposed wafer T or the processing target wafer W and the second transfer arm 191 holding and transferring the supporting wafer S respectively in the above embodiment. The first transfer apparatus 430 moves inside the wafer transfer region 414 to be able to transfer the processing target wafer W, the supporting wafer S, and the superposed wafer T between the transfer-in/out station 410 and the separation processing station 411.

The separation processing station 411 has a separation apparatus 12 separating the superposed wafer T into the processing target wafer W and the supporting wafer S. On a Y-direction negative direction side (a left direction side in FIG. 34) of the separation apparatus 12, a first cleaning apparatus 13 cleaning the separated processing target wafer W is arranged. Between the separation apparatus 12 and the first cleaning apparatus 13, a second transfer apparatus 440 is arranged. Further, on a Y-direction positive direction side (a right direction side in FIG. 34) of the separation apparatus 12, a second cleaning apparatus 441 is arranged as another cleaning apparatus cleaning the separated supporting wafer S. As described above, the first cleaning apparatus 13, the second transfer apparatus 440, the separation apparatus 12, and the second cleaning apparatus 441 are arranged side by side in this order from the interface station 413 side in the separation processing station 411. Note that the separation apparatus 12 has the same configuration as that of the separation apparatus 12 in the separation system 1 of the above embodiment. Further, the first cleaning apparatus 13 also has the same configuration as that of the cleaning apparatus 13 in the separation system 1, but is called the first cleaning apparatus 13 for convenience of discrimination from the second cleaning apparatus 441.

The inspection apparatus 415 inspects the presence or absence of the residual of the adhesive G on the processing target wafer W separated by the separation apparatus 12. Further, the post-inspection cleaning apparatus 416 cleans the processing target wafer W for which the residual of the adhesive G has been confirmed in inspection apparatus 415. The post-inspection cleaning apparatus 416 has a joint surface cleaning part 416a cleaning the joint surface W_{J} of the processing target wafer W, a non-joint surface cleaning part 416b cleaning the non-joint surface W_{N} of the processing target wafer W, and a reversing part 416c vertically reversing the processing target wafer W. Note that the joint surface cleaning part 416a and the non-joint surface cleaning part 416b have the same configuration as that of the first cleaning apparatus 13.

In the interface station 413, a third transfer apparatus 451 movable on a transfer path 450 extending in the Y-direction is provided. The third transfer apparatus 451 is also movable in the vertical direction and around the vertical axis (in a θ-direction), and thus can transfer the processing target wafer W between the separation processing station 411, the post-processing station 412, the inspection apparatus 415, and the post-inspection cleaning apparatus 416.

Note that the post-processing station 412 performs predetermined post-processing on the processing target wafer W separated in the separation processing station 411. As the predetermined post-processing, processing such as inspecting the electric properties of the devices on the processing target wafer W and so on are performed.

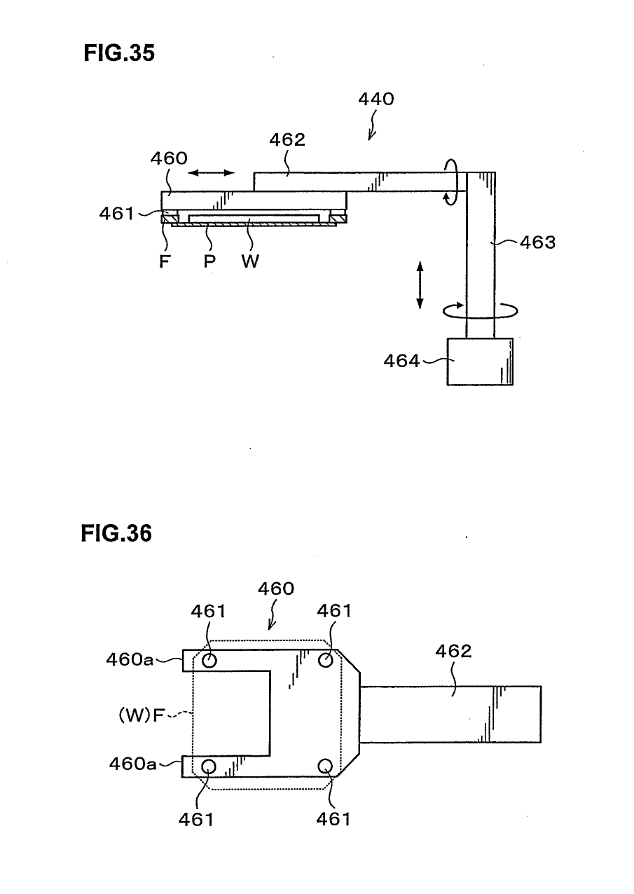

Next, the configuration of the above-described second transfer apparatus 440 will be described. The second transfer apparatus 440 has a transfer arm 460 holding and transferring the processing target wafer W as illustrated in FIG. 35. Note that the processing target wafer W transferred by the transfer arm 460 is held by the dicing frame F and the dicing tape P.

The transfer arm 460 has a shape in which a tip thereof is branched off into two tip end portions 460a, 460a as illustrated in FIG. 36. At the transfer arm 460, suction pads 461 sucking and holding the processing target wafer W via the dicing frame F (or the dicing tape P) are provided. This enables the transfer arm 460 to horizontally hold the processing target wafer W on the transfer arm 460.

The transfer arm 460 is supported by a supporting arm 462 as illustrated in FIG. 35. The supporting arm 462 is supported by a first drive part 463. By means of the first drive part 463, the supporting arm 462 can freely turn around a horizontal axis and expand and contract in the horizontal direction. Below the first drive part 463, a second drive part 464 is provided. By means of the second drive part 464, the first drive part 463 can rotate around the vertical axis and rise and lower in the vertical direction.

Note that the third transfer apparatus 451 has the same configuration as that of the above-described second transfer apparatus 440. Incidentally, the second drive part 464 of the third transfer apparatus 451 is attached to the transfer path 450 illustrated in FIG. 34 so that the third transfer apparatus 451 is movable on the transfer path 450.

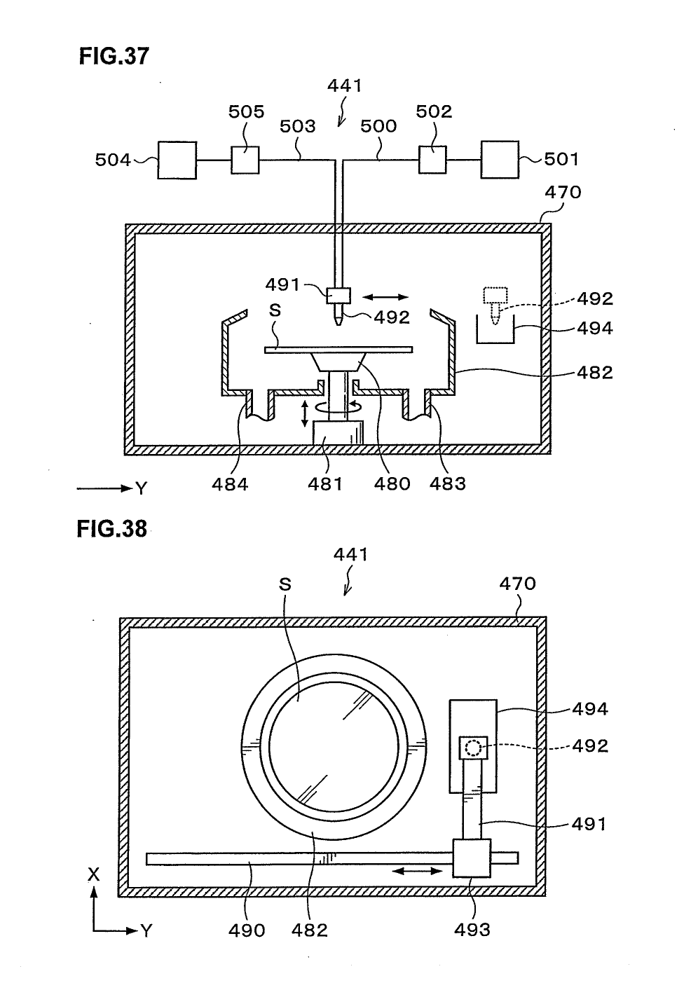

Next, the configuration of the above-described second cleaning apparatus 441 will be described. The first cleaning apparatus 13 has a treatment container 470 as illustrated in FIG. 37. In a side surface of the treatment container 470, a transfer-in/out port (not illustrated) for the supporting wafer S is formed, and an opening/closing shutter (not illustrated) is provided at the transfer-in/out port.

At a center portion inside the treatment container 470, a spin chuck 480 holding and rotating the supporting wafer S thereon is provided. The spin chuck 480 has a horizontal upper surface, and a suction port (not illustrated) sucking, for example, the supporting wafer S is provided in the upper surface. By suction through the suction port, the supporting wafer S can be suction-held on the spin chuck 480.

Below the spin chuck 480, a chuck drive part 481 equipped with, for example, a motor is provided. The spin chuck 480 can rotate at a predetermined speed by means of the chuck drive part 481. Further, the chuck drive part 481 is provided with a raising and lowering drive source such as, for example, a cylinder so that the spin chuck 480 can freely rise and lower.

Around the spin chuck 480, a cup 482 is provided which receives and collects liquid splashing or dropping from the supporting wafer S. A drain pipe 483 draining the collected liquid and an exhaust pipe 484 evacuating and exhausting the atmosphere in the cup 482 are connected to the lower surface of the cup 482.

As illustrated in FIG. 38, on an X-direction negative direction (a lower direction in FIG. 38) side of the cup 482, a rail 490 extending along a Y-direction (a right-left direction in FIG. 38) is formed. The rail 490 is formed, for example, from a Y-direction negative direction (a left direction in FIG. 38) side outer position of the cup 482 to a Y-direction positive direction (a right direction in FIG. 38) side outer position. On the rail 490, an arm 491 is attached.

On the arm 491, a cleaning solution nozzle 492 supplying a cleaning solution, for example, an organic solvent onto the supporting wafer S is supported as illustrated in FIG. 37 and FIG. 38. The arm 491 is movable on the rail 490 by means of a nozzle drive part 493 illustrated in FIG. 38. Thus, the cleaning solution nozzle 492 can move from a waiting section 494 provided at the Y-direction positive direction side outer position of the cup 482 to a position above a central portion of the supporting wafer S in the cup 482, and further move in the diameter direction of the supporting wafer S above the supporting wafer S. Further, the arm 491 can freely rise and lower by means of the nozzle drive part 493 to be able to adjust the height of the cleaning solution nozzle 492.

As the cleaning solution nozzle 492, for example, a dual fluid nozzle is used. To the cleaning solution nozzle 492, a supply pipe 500 supplying the cleaning solution to the cleaning solution nozzle 492 is connected as illustrated in FIG. 37. The supply pipe 500 communicates with a cleaning solution supply source 501 storing the cleaning solution therein. Along the supply pipe 500, a supply equipment group 502 is provided which includes a valve, a flow regulator and so on for controlling the flow of the cleaning solution. Further, a supply pipe 503 supplying an inert gas, for example, a nitrogen gas to the cleaning solution nozzle 492 is connected to the cleaning solution nozzle 492. The supply pipe 503 communicates with an inert gas supply source 504 storing the inert gas therein. Along the supply pipe 503, a supply equipment group 505 is provided which includes a valve, a flow regulator and so on for controlling the flow of the inert gas. The cleaning solution and the inert gas are mixed in the cleaning solution nozzle 492 and supplied from the cleaning solution nozzle 492 to the supporting wafer S. Note that the mixture of the cleaning solution and the inert gas is sometimes referred to simply as a “cleaning solution” hereinafter.

Incidentally, below the spin chuck 480, raising and lowering pins (not illustrated) for supporting the supporting wafer S from below and raising and lowering it may be provided. In this case, the raising and lowering pins pass through through holes (not illustrated) formed in the spin chuck 480 and can project from the upper surface of the spin chuck 480. Then, instead of raising and lowering the spin chuck 480, the raising and lowering pins are raised or lowered to deliver the supporting wafer S to/from the spin chuck 480.

Further, in the second cleaning apparatus 441, a back rinse nozzle (not illustrated) jetting a cleaning solution toward the rear surface of the supporting wafer S, namely, the non-joint surface S_{N} may be provided below the spin chuck 480. The cleaning solution jetted from the back rinse nozzle cleans the non-joint surface S_{N} of the supporting wafer S and the outer peripheral portion of the supporting wafer S.

Next, the separation processing method for the processing target wafer W and the supporting wafer S performed using the separation system 400 configured as described above will be described.

First, a cassette C_{T} housing a plurality of superposed wafers T, an empty cassette C_{W}, and an empty cassette C_{S} are mounted on the predetermined cassette mounting plates 421 in the transfer-in/out station 410. The superposed wafer T in the cassette C_{T} is taken out by the first transfer apparatus 430 and transferred to the separation apparatus 12 in the separation processing station 411. In this event, the superposed wafer T is held by the dicing frame F and the dicing tape P and transferred with the processing target wafer W placed on the upper side and the supporting wafer S placed on the lower side.

The superposed wafer T transferred in the separation apparatus 12 is separated into the processing target wafer W and the supporting wafer S. The separation method for the processing target wafer W and the supporting wafer S in the separation apparatus 12 is the same as the method described in the above embodiment, and the description thereof will be omitted.

The processing target wafer W separated in the separation apparatus 12 is then transferred by the second transfer apparatus 440 to the first cleaning apparatus 13. Here, the transfer method of the processing target wafer W by the second transfer apparatus 440 will be described. Note that the processing target wafer W is held by the dicing frame F and the dicing tape P.

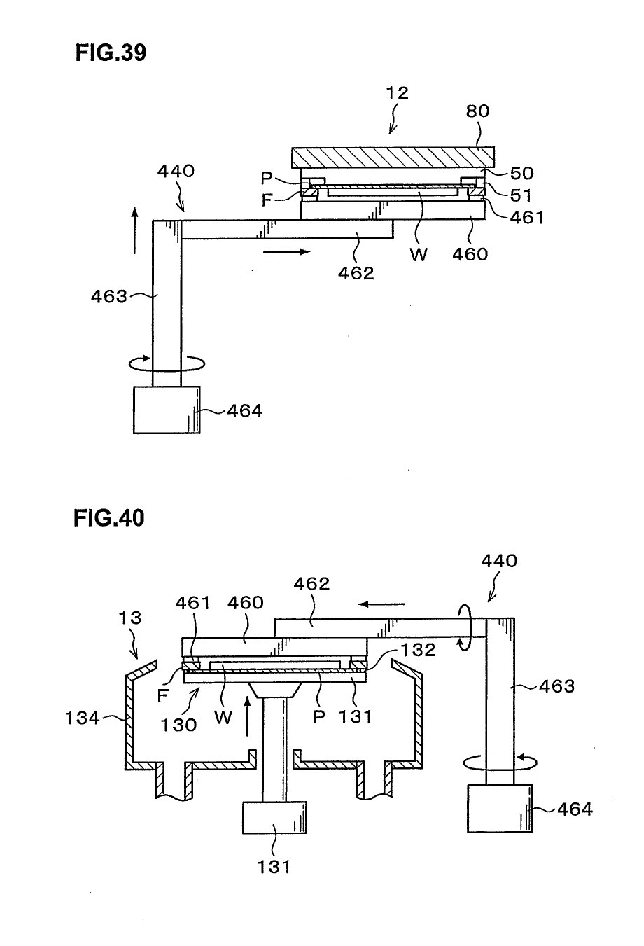

As illustrated in FIG. 39, the supporting arm 462 is extended to locate the transfer arm 460 below the processing target wafer W held by the first holding part 50. Thereafter, the transfer arm 460 is raised, and the suction of the processing target wafer W through the suction pipe 60 at the first holding part 50 is stopped. Then, the processing target wafer W is delivered from the first holding part 50 to the transfer arm 460.

Next, as illustrated in FIG. 40, the supporting arm 462 is turned to move the transfer arm 460 to above the wafer holding part 130 in the first cleaning apparatus 13 and reverses the transfer arm 460 to thereby direct the processing target wafer W downward. In this event, the wafer holding part 130 is raised to a position upper than the cup 134 and kept waiting. Thereafter, the processing target wafer W is delivered from the transfer arm 460 to the wafer holding part 130 and suction-held thereon.

Once the processing target wafer W is suction-held on the wafer holding part 130 in this manner, the wafer holding part 130 is lowered down to a predetermined position. Subsequently, the cleaning jig 140 cleans the joint surface W_{J} of the processing target wafer W. Note that the cleaning method for the joint surface W_{J} of the processing target wafer W in the first cleaning apparatus 13 is the same as the method described in the above embodiment and the description thereof will be omitted.

Here, the plurality of superposed wafers T transferred into the transfer-in/out station 410 have been subjected to inspection in advance as described above and judged whether they are the superposed wafer T including a normal processing target wafer W or the superposed wafer T including a defective processing target wafer W.

The normal processing target wafer W separated from the normal superposed wafer T is transferred by the third transfer apparatus 451 to the inspection apparatus 415 after the joint surface W_{J} is cleaned in the first cleaning apparatus 13. Note that the transfer of the processing target wafer W by the third transfer apparatus 451 is almost the same as the transfer of the processing target wafer W by the above-described second transfer apparatus 440, and the description thereof will be omitted.

The inspection apparatus 415 inspects the presence or absence of the residual of the adhesive G on the joint surface W_{J} of the processing target wafer W. When the residual of the adhesive G has been confirmed in the inspection apparatus 415, the processing target wafer W is transferred by the third transfer apparatus 451 to the joint surface cleaning part 416a of the post-inspection cleaning apparatus 416, and the joint surface W_{J} is cleaned in the joint surface cleaning part 416a. After the joint surface W_{J} is cleaned, the processing target wafer W is transferred by the third transfer apparatus 451 to the reversing part 416c and reversed in the vertical direction in the reversing part 416c. Note that when the residual of the adhesive G has not been confirmed, the processing target wafer W is not transferred to the joint surface cleaning part 416a but is reversed in the reversing part 416c.

The reversed processing target wafer W is then transferred by the third transfer apparatus 451 again to the inspection apparatus 415, and the non-joint surface W_{N} is inspected. When the residual of the adhesive G on the non-joint surface W_{N} has been confirmed, the processing target wafer W is transferred by the third transfer apparatus 451 to the non-joint surface cleaning part 416b, where the non-joint surface W_{N} is cleaned. Then, the cleaned processing target wafer W is transferred by the third transfer apparatus 451 to the post-processing station 412. Note that when the residual of the adhesive G has not been confirmed in the inspection apparatus 415, the processing target wafer W is not transferred to the non-joint surface cleaning part 416b but is transferred as it is to the post-processing station 412.

Thereafter, the predetermined post-processing is performed on the processing target wafer W in the post-processing station 412. In this manner, the processing target wafer W is made into a product.

On the other hand, the defective processing target wafer W separated from the defective superposed wafer T is transferred by the first transfer apparatus 430 to the cassette C_{W} in the transfer-in/out station 410 after the joint surface W_{J} is cleaned in the first cleaning apparatus 13. The defective processing target wafer W is then transferred from the transfer-in/out station 410 to the outside and collected.

During the time when the above-described processing is being performed on the processing target wafer W separated in the separation apparatus 12, the supporting wafer S separated in the separation apparatus 12 is transferred by the first transfer apparatus 430 to the second cleaning apparatus 441.

The supporting wafer S transferred into the second cleaning apparatus 441 is suction-held on the spin chuck 480. Then, the spin chuck 480 is lowered down to a predetermined position. Subsequently, the cleaning solution nozzle 492 at the waiting section 494 is moved by the arm 491 to above the central portion of the supporting wafer S. Thereafter, while the spin chuck 480 is rotating the supporting wafer S, the cleaning solution is supplied from the cleaning solution nozzle 492 to the joint surface S_{J} of the supporting wafer S. The supplied cleaning solution is diffused over the entire joint surface S_{J} of the supporting wafer S by the centrifugal force, whereby the joint surface S_{J} of the supporting wafer S is cleaned.

The supporting wafer S cleaned in the second cleaning apparatus 441 is transferred by the first transfer apparatus 430 to the cassette C_{S} in the transfer-in/out station 410. The supporting wafer S is then transferred from the transfer-in/out station 410 to the outside and collected. Thus, a series of separation processing of the processing target wafer W and the supporting wafer S in the separation system 400 ends.

According to the separation system 400 in this embodiment, it is possible to separate the superposed wafer T into the processing target wafer W and the supporting wafer S in the separation apparatus 12, and then clean the separated processing target wafer W in the first cleaning apparatus 13 and clean the separated supporting wafer S in the second cleaning apparatus 441. As described above, according to this embodiment, a series of separation processing from the separation of the processing target wafer W and the supporting wafer S to the cleaning of the processing target wafer W and the cleaning of the supporting wafer S can be efficiently performed in one separation system 400. Further, the cleaning of the processing target wafer W and the cleaning of the supporting wafer S can be performed in parallel in the first cleaning apparatus 13 and the second cleaning apparatus 441 respectively. Further, while the processing target wafer W and the supporting wafer S are being separated in the separation apparatus 12, other processing target wafer W and supporting wafer S can also be processed in the first cleaning apparatus 13 and the second cleaning apparatus 441. Therefore, it is possible to efficiently perform the separation of the processing target wafer W and the supporting wafer S and improve the throughput of the separation processing.

Further, since processing from the separation of the processing target wafer W and the supporting wafer S to the post-processing of the processing target wafer W can be performed in the series of processes, the throughput of the wafer processing can further be improved.

In the separation system 400 of the above embodiment, a temperature regulator (not illustrated) cooling the processing target wafer W, which has been heated in the separation apparatus 12, to a predetermined temperature may be provided. In this case, since the temperature of the processing target wafer W is regulated to an appropriate temperature, the processing subsequent thereto can be more smoothly performed.

Further, though the case where the post-processing is performed on the processing target wafer W in the post-processing station 412 into a product has been described in the above embodiment, the present invention is also applicable to the case where a processing target wafer used, for example, in the three-dimensional integration technique is separated from a supporting wafer. Note that the three-dimensional integration technique is the technique responding to the demand for higher integration of semiconductor devices in recent years, which three-dimensionally stacks a plurality of highly integrated semiconductor devices instead of arranging the highly integrated semiconductor devices within a horizontal surface. Also in this three-dimensional integration technique, the reduction in thickness of the processing target wafers to be stacked is required, and the processing target wafer is joined with the supporting wafer and subjected to the predetermined processing.

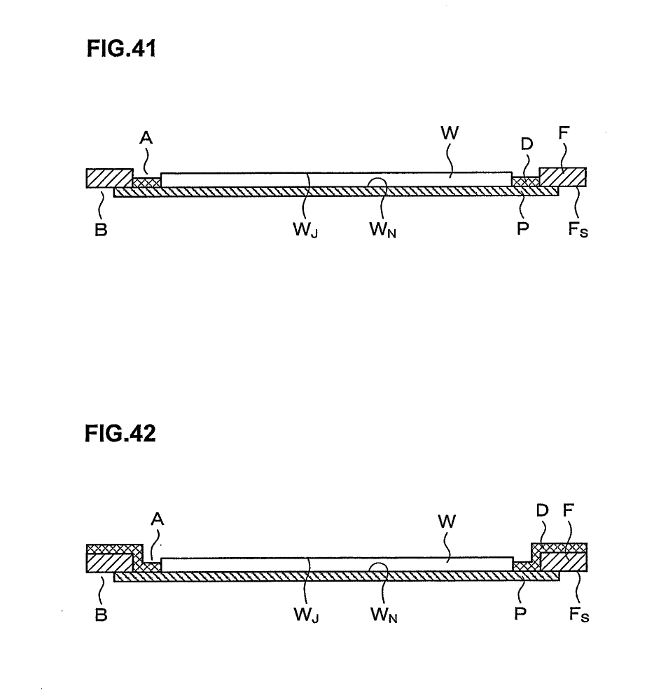

In the above embodiment, an annular protective tape D may be provided on the dicing tape P at the stepped portion A between the processing target wafer W and the dicing frame F as illustrated in FIG. 41. In other words, the protective tape D is provided such that any exposed portion of the dicing tape P does not exist in a plan view. Note that as the protective tape D, a material having corrosion resistance to the solvent L for the adhesive G is used, for example, a fluorine-based resin such as Teflon (registered trademark) is used.

The protective tape D may be provided before the superposed wafer T is mounted on the dicing frame F or at the time when the superposed wafer T is mounted on the dicing frame F. In the case where the protective tape D is provided before the superposed wafer T is mounted, for example, the dicing tape P having the protective tape D bonded at a predetermined position thereof is bonded to the dicing frame F and the superposed wafer T. Further, in the case where the protective tape D is provided at the time when mounting the superposed wafer T, the protective tape D may be held, for example, by a holding member (not illustrated) and bonded on the dicing tape P at the stepped portion A between the processing target wafer W and the dicing frame F, or a protective material may be applied onto the dicing tape P at the stepped portion A between the processing target wafer W and the dicing frame F to provide the protective tape D.

In this case, when cleaning the processing target wafer W in the cleaning apparatus 13, even if the solvent L is supplied from the supply port 153 to the gap 142 between the supply surface 141 and the joint surface W_{J} via the solvent supply part 150 and the solvent L flows into the stepped portion A between the processing target wafer W and the dicing frame F, the damage to the dicing tape P due to the solvent L can be suppressed by the protective tape D.

Further, since the protective tape D has corrosion resistance to the solvent L, the damage to the dicing tape P due to the solvent L can be more surely suppressed. Note that it is only necessary that even when the protective tape D does not have corrosion resistance to the solvent L, the solvent L flowing into the stepped portion A does not come into contact with the dicing tape P. In other words, it is only necessary that even if the protective tape D is corroded with the solvent L, the solvent L does not reach the surface of the dicing tape P.

In the above embodiment, the protective tape D may be provided to cover the dicing tape P at the stepped portion A between the processing target wafer W and the dicing frame F and to cover the dicing frame F as illustrated in FIG. 42. In this case, it is possible to prevent the solvent L from contaminating the dicing frame F. It is also possible to easily peel off the protective tape D from the dicing tape P after the finish of the processing on the processing target wafer W.

Note that as a result of earnest study of the inventors, it was found that in the case of using isododecane or menthane for the solvent L for the adhesive G when cleaning the processing target wafer W in the cleaning apparatus 13, the dicing tape P did not deteriorate due to the solvent L. It was also verified that the joint surface W_{J} of the processing target wafer W was able to be sufficiently cleaned with a solvent L for isododecane or menthane. Accordingly, in the case of using this solvent L, even if the dicing tape P is exposed, that is, for example, even if the protective tape D is omitted, the processing target wafer W can be appropriately cleaned while suppressing the damage to the dicing tape P due to the solvent L.

Preferred embodiments of the present invention have been described above with reference to the accompanying drawings, but the present invention is not limited to the embodiments. It should be understood that various changes and modifications are readily apparent to those skilled in the art within the scope of the spirit as set forth in claims, and those should also be covered by the technical scope of the present invention. The present invention is not limited to the embodiments but can take various aspects. The present invention is also applicable to the case where the substrate is a substrate other than the wafer, such as an FPD (Flat Panel Display), a mask reticle for a photomask or the like.

What is claimed is:

1. A separation apparatus for separating a superposed substrate in which a processing target substrate and a supporting substrate are joined together with an adhesive, into the processing target substrate and the supporting substrate while the superposed substrate is placed inside an annular frame and held by a tape bonded to a surface of the frame and a non-joint surface of the processing target substrate, said separation apparatus comprising:
one holding part holding the processing target substrate via the tape;
another holding part holding the supporting substrate; and
a moving mechanism moving said another holding part in a vertical direction while holding an outer peripheral portion thereof to continuously separate the supporting substrate held by said another holding part from the processing target substrate held by said one holding part starting from an outer peripheral portion toward a central portion of the supporting substrate,
wherein said moving mechanism comprises:
a first moving part holding said another holding part and moving only the outer peripheral portion of said another holding part in the vertical direction; and
a second moving part moving said first moving part and said another holding part in the vertical direction.

2. The separation apparatus as set forth in claim 1,
wherein said one holding part is arranged above said another holding part, and
wherein said moving mechanism moves said another holding part vertically downward.

3. The separation apparatus as set forth in claim 1,
wherein said one holding part has a heating mechanism heating the processing target substrate, and
wherein said another holding part has a heating mechanism heating the supporting substrate.

4. The separation apparatus as set forth in claim 1,
wherein said first moving part comprises:
a plurality of cylinders moving the outer peripheral portion of said another holding part in the vertical direction; and
a supporting post supporting a central portion of said another holding part to prevent a position in the vertical direction of the central portion of said another holding part from changing when said plurality of cylinders move the outer peripheral portion of said another holding part in the vertical direction.

5. The separation apparatus as set forth in claim 1, further comprising:
a holding part holding the frame outside the tape.

6. A separation apparatus for separating a superposed substrate in which a processing target substrate and a supporting substrate are joined together with an adhesive, into the processing target substrate and the supporting substrate while the superposed substrate is placed inside an annular frame and held by a tape bonded to a surface of the frame and a non-joint surface of the processing target substrate, said separation apparatus comprising:
one holding part holding the processing target substrate via the tape;
another holding part holding the supporting substrate;
a moving mechanism moving said another holding part in a vertical direction while holding an outer peripheral portion thereof to continuously separate the supporting substrate held by said another holding part from the processing target substrate held by said one holding part starting from an outer peripheral portion toward a central portion of the supporting substrate; and
a control unit controlling said one holding part, said another holding part, and said moving mechanism to perform a first step of moving the outer peripheral portion of said another holding part in the vertical direction, while holding the processing target substrate by said one holding part and holding the supporting substrate by said another holding part, to continuously separate the supporting substrate from the processing target substrate starting from the outer peripheral portion toward the central portion, and a second step of then moving said whole another holding part in the vertical direction to separate the supporting substrate from the processing target substrate.

7. A separation system comprising a separation apparatus for separating a superposed substrate in which a processing target substrate and a supporting substrate are joined together with an adhesive, into the processing target substrate and the supporting substrate while the superposed substrate is placed inside an annular frame and held by a tape bonded to a surface of the frame and a non-joint surface of the processing target substrate,
said separation apparatus comprising:
one holding part holding the processing target substrate via the tape;
another holding part holding the supporting substrate;
a moving mechanism moving said another holding part in a vertical direction while holding an outer peripheral portion thereof to continuously separate the supporting substrate held by the another holding part from the processing target substrate held by the one holding part starting from an outer peripheral portion toward a central portion of the supporting substrate,
the moving mechanism comprising:
a first moving part holding said another holding part and moving only the outer peripheral portion of said another holding part in the vertical direction; and
a second moving part moving said first moving part and said another holding part in the vertical direction,
said separation system comprising:
a separation processing station comprising said separation apparatus, a first cleaning apparatus cleaning the processing target substrate separated in said separation apparatus, and a second cleaning apparatus cleaning the supporting substrate separated in said separation apparatus;
a transfer-in/out station transferring the processing target substrate, the supporting substrate, or the superposed substrate into/from said separation processing station; and
a transfer apparatus transferring the processing target substrate, the supporting substrate, or the superposed substrate between said separation processing station and said transfer-in/out station.

8. A separation method of separating, using a separation apparatus, a superposed substrate in which a processing target substrate and a supporting substrate are joined together with an adhesive, into the processing target substrate and the supporting substrate while the superposed substrate is placed inside an annular frame and held by a tape bonded to a surface of the frame and a non-joint surface of the processing target substrate,
the separation apparatus comprising:
one holding part holding the processing target substrate via the tape;
another holding part holding the supporting substrate; and
a moving mechanism moving the another holding part in a vertical direction while holding an outer peripheral portion thereof to continuously separate the supporting substrate held by the another holding part from the processing target substrate held by the one holding part starting from an outer peripheral portion toward a central portion of the supporting substrate,
said separation method comprising:
a first step of moving the outer peripheral portion of the another holding part in the vertical direction, while holding the processing target substrate by the one holding part and holding the supporting substrate by the another holding part, to continuously separate the supporting substrate from the processing target substrate starting from the outer peripheral portion toward the central portion; and
a second step of then moving the whole another holding part in the vertical direction to separate the supporting substrate from the processing target substrate.

9. The separation method as set forth in claim 8,
wherein the one holding part is arranged above the another holding part, and
wherein the another holding part is moved vertically downward in said first step and said second step.

10. The separation method as set forth in claim 8,
wherein the one holding part has a heating mechanism heating the processing target substrate,
wherein the another holding part has a heating mechanism heating the supporting substrate, and
wherein said first step and said second step are performed while heating the processing target substrate held by the one holding part and the supporting substrate held by the another holding part.

11. The separation method as set forth in claim 8,
wherein the separation apparatus comprises a holding part holding the frame outside the tape, and
wherein the frame is held by the holding part in said first step.

12. A non-transitory computer readable storage medium storing a program running on a computer of a control unit controlling a separation apparatus to cause the separation apparatus to perform a separation method of separating, using a separation apparatus, a superposed substrate in which a processing target substrate and a supporting substrate are joined together with an adhesive, into the processing target substrate and the supporting substrate while the superposed substrate is placed inside an annular frame and held by a tape bonded to a surface of the frame and a non-joint surface of the processing target substrate,
the separation apparatus comprising:
one holding part holding the processing target substrate via the tape;
another holding part holding the supporting substrate; and
a moving mechanism moving the another holding part in a vertical direction while holding an outer peripheral portion thereof to continuously separate the supporting substrate held by the another holding part from the processing target substrate held by the one holding part starting from an outer peripheral portion toward a central portion of the supporting substrate, and
the separation method comprising:
a first step of moving the outer peripheral portion of the another holding part in the vertical direction, while holding the processing target substrate by the one holding part and holding the supporting substrate by the another holding part, to continuously separate the supporting substrate from the processing target substrate starting from the outer peripheral portion toward the central portion; and
a second step of then moving the whole another holding part in the vertical direction to separate the supporting substrate from the processing target substrate.
